(19) United States
(12) Patent Application Publication
(10) Pub. No.: US 2013/0145327 A1
(43) Pub. Date: Jun. 6, 2013

(54) Interfaces for Displaying an Intersection Space

(71) Applicants: Peter Rinearson, Vashon, WA (US); Daniel Jaeger, Seattle, WA (US); Nadja Haldimann, Seattle, WA (US)

(72) Inventors: Peter Rinearson, Vashon, WA (US); Daniel Jaeger, Seattle, WA (US); Nadja Haldimann, Seattle, WA (US)

(73) Assignee: INTERSECT PTP, INC., SEATTLE, WA (US)

(21) Appl. No.: 13/491,500

(22) Filed: Jun. 7, 2012

Related U.S. Application Data
(60) Provisional application No. 61/494,129, filed on Jun. 7, 2011.

(51) Int. Cl. G06F 3/01

(52) U.S. Cl. CPC G06F 3/017
USPC 715/863

(57) ABSTRACT

User-submitted content (e.g., stories) may be associated with descriptive metadata, such as a timeframe, location, tags, and so on. The user-submitted content may be browed and/or searched using the descriptive metadata. Intersection criteria comprising a prevailing timeframe, a location, and/or other metadata criteria may be used to identify an intersection space comprising one or more stories. The stories may be ordered according to relative importance, which may be determined (at least in part) by comparing story metadata to the intersection criteria. Stories may be browsed in an intersection interface comprising a timeframe control. The intersection interface (and the timeframe control) may be configured to receive inputs in various forms including gesture input, movement input, orientation input, and so on.

### CROSS-REFERENCE TO RELATED APPLICATIONS

This application claims priority to U.S. Provisional Application No. 61/494,129, entitled “Interfaces for Displaying an Intersection Space,” filed on Jun. 7, 2011, and which is hereby incorporated by reference.

### TECHNICAL FIELD

This disclosure relates to interfaces for displaying an intersection space, and specifically, intersection interfaces configured to receive gesture input.

### BRIEF DESCRIPTION OF THE DRAWINGS

FIG. 1 depicts exemplary intersections;

FIG. 2 is a flow diagram of a method for identifying intersections;

FIG. 3A depicts one embodiment of an interface for presenting an intersection space;

FIG. 3B depicts another embodiment of an interface for presenting an intersection space;

FIG. 3C depicts one embodiment of an interface for presenting a user-submitted content, such as a story;

FIG. 4 is a flow diagram of one embodiment of a method for ordering stories in an intersection space;

FIG. 5A is a flow diagram of one embodiment of a method for ordering content chronologically;

FIG. 5B depicts examples of chronological ordering;

FIG. 6A depicts one embodiment of a method for ordering content by location;

FIG. 6B depicts examples of location ordering;

FIG. 7 depicts examples of item chronology;

FIG. 8 is a flow diagram of one embodiment of a method for identifying important items in a chronology;

FIGS. 9A-C depict embodiments of a timeframe control interface element;

FIGS. 10A-C depict an intersection interface configured to respond to touch input;

FIGS. 11A-B depicts intersection interfaces configured to respond to touch input;

FIGS. 12A-E depict another intersection interface configured to respond to touch input;

FIG. 13 depicts an intersection interface configured to respond to movement input;

FIG. 14 depicts another intersection interface configured to respond to movement input;

FIG. 15 depicts another intersection interface configured to respond to touch input;

FIGS. 16A-B depict another intersection interface configured to respond to touch input;

FIG. 17 depict another intersection interface configured to respond to touch input;

FIG. 18 is a flow diagram of one embodiment of a method for displaying a timeframe control interface element;

FIG. 19 is a block diagram of a system and apparatus for providing a network-accessible service as disclosed herein; and

FIG. 20 is a flow diagram of one embodiment of a method for displaying an intersection space on a display of a gesture-enabled computing device.

### DETAILED DESCRIPTION

Websites and/or web services featuring user-submitted content are becoming increasingly popular and are among the most heavily trafficked websites on the Internet. Content submitted to such websites is often transient and can be lost or removed over time. Moreover, given the high volume of user-submitted content, it may be difficult to find content of interest to particular users.

As will be described below, the value of user-submitted content may be increased by associating the content with descriptive metadata. As used herein “content,” “user-submitted content,” and/or a “content item” may refer to any content or content item known in the art including, but not limited to: text, images, video, audio, executable code, markup language, or the like. In some embodiments, the metadata may include a timeframe and/or location (among other things). The timeframe and location metadata may be used to group the content of a particular user into a “chronology,” identify “intersections” between an intersection criteria (e.g., timeframe and/or location) and content, provide for convenient browsing and/or searching within dynamic “intersection spaces,” and so on. Exemplary mechanisms for identifying and presenting such intersections are disclosed in U.S. Provisional Patent Application No. 61/347,815, entitled “Intersect,” which was filed on May 24, 2010, which is hereby incorporated by reference in its entirety.

The teachings of the disclosure may be implemented using a generalized network-accessible service, which may be configured to allow users to: author, contribute, upload, and/or publish user-submitted content; manage content collections (e.g., storylines); present content including user-submitted content; search or browse user-submitted content; manage user profile or account information; maintain user privacy settings; manage access control preferences; and so on, as disclosed herein. Accordingly, the network-accessible service may comprise one or more computing devices, datastores (e.g., databases, computer-readable storage media, directories, and the like), communications interfaces, and other hardware and/or software components.

Users may access the network-accessible service using a computing device, such as a personal computer, a Personal Digital Assistant (PDA), a kiosk, a cellular phone, a handheld computer, a notebook computer, a netbook, a tablet computer, or the like. User access may be provided via any communication mechanisms known in the art including, but not limited to: a Transmission Control Protocol/Internet Protocol (TCP/IP) network (e.g., the Internet), a Local Area Network (LAN), a Wide Area Network (WAN), a Virtual Private Network (VPN), a Public Switched Telephone Network (PSTN), a wireless network (e.g., radio, IEEE 802.11), a combination of networks, and so on.

In some embodiments, the network-accessible service may provide various user interfaces adapted for display on the various types of computing devices described above. The interfaces may be implemented using any user-interface mechanism known in the art. The interfaces may be provided as: Hyper Text Markup Language (HTML) interfaces, Virtual Reality Modeling Language (VRML) interfaces, text interfaces (e.g., TELNET), audio interfaces, Accessibility interfaces (e.g., a11y interfaces), and so on. Alternatively, or in addition, the network-accessible service may be configured to interact with one or more dedicated, client application(s), which may be special purpose applications installed on a user computing device and/or operating as plug-ins to other applications (e.g., operating as a browser application plug-in, an applet (or “app”), or the like).

In some embodiments, a network-accessible service may be implemented as a website (a computing system comprising one or more server computing devices). The website may be configured to provide interfaces and/or interface components in a browser-renderable format, such as HTML. However, as discussed above, the disclosure is not limited in this regard, and could be implemented using any interaction technique known in the art.

A contributor may submit a “story” to a network-accessible service (e.g., website). As used herein, a story may comprise content (one or more content items) and associated descriptive metadata. A story may contain one or more content items, which, as described above, may include, but are not limited to: images, video, text, audio, executable code, and the like. Accordingly, as used herein, a “story” may refer to a single content item (e.g., a single picture), a collection of content items (or the same of different types, e.g., photos with accompanying text), multi-media content, or the like. Story content (e.g., story content items) may comprise user-submitted content, user-authored content, linked content (e.g., content submitted by other users and/or available on at network-accessible locations (e.g., other websites or services), or the like, as described above. A story may be associated with descriptive metadata, such as a timeframe, location information, people identified as story participants, people identified as finding the story of interest, identification of the story contributor, descriptive tags, rating information, and so on.

Timeframe metadata may specify the “prevailing time” of a story. In some embodiments, the timeframe may indicate the timeframe during which the events described in a story took place. The story timeframe may be determined by the story contributor. For example, the timeframe of a story about a sporting event (e.g., football game) may comprise the time from the kickoff to the end of the game, a story about a particular play may be assigned a different timeframe (e.g., the last thirty seconds of the game), and the timeframe of a story about a fan's experience at the game may start when the fan arrives at the parking lot to tailgate and end in the middle of the first half when the fan becomes sick and has to leave. Alternatively, or in addition, timeframe metadata may be used to indicate a time period during which the story is “relevant,” and, in some cases, may be open ended. For instance, the timeframe of a story about the contributor's life in a particular town may begin at the time the contributor moves to the town and may not be assigned an ending point until the contributor moves away.

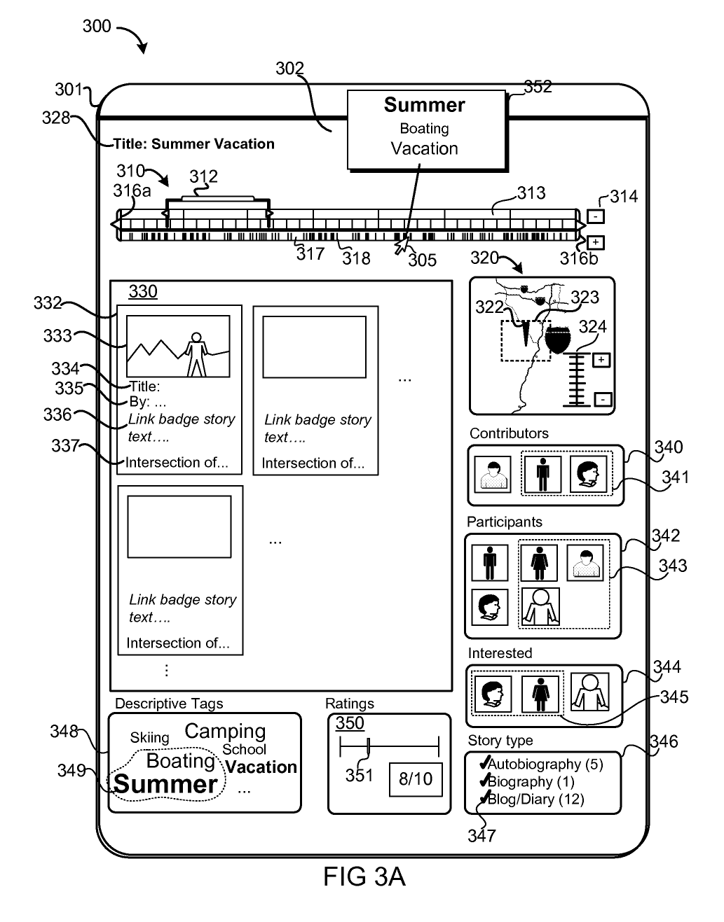

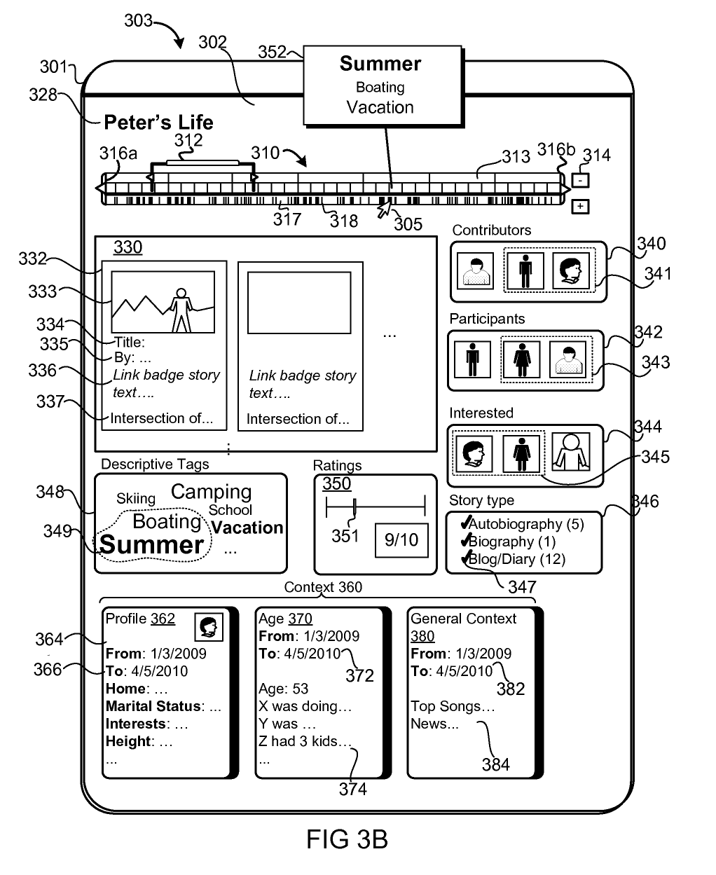

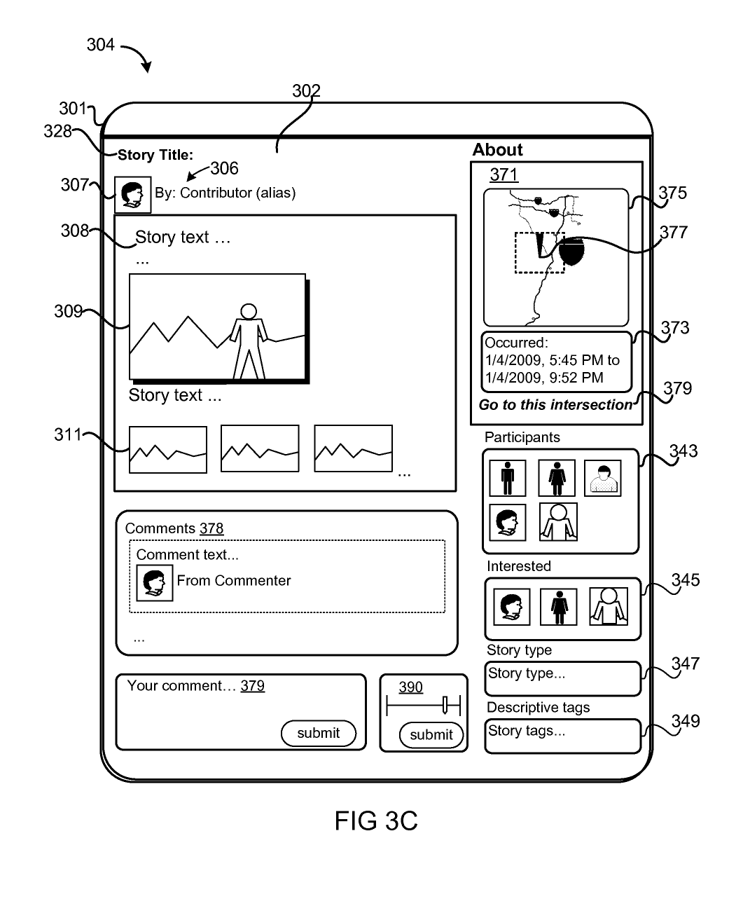

In some embodiments, the network-accessible service (e.g., website) may provide search and/or browse features (discussed below) to allow users to find story content using the metadata associated therewith, such as the story timeframe and/or location. These features allow users to identify “intersections” between stories and particular timeframes and locations (or other criteria). As used herein, a time and location intersection (referred to generally as an “intersection”) refers to a similarity or “overlap” in the time and location metadata of a story a time and/or a location of interest (referred to generally as “intersection criteria”). For example, intersection criteria may define a timeframe and/or location of interest to a particular user, such as the time and place a youth sporting event took place. The intersection criteria may be provided by a user via a search or browsing interface, such as the interfaces described below in conjunction with FIGS. 3A and 3B. Alternatively, the intersection criteria may be derived from a particular story.

Using the intersection criteria, components of the network-accessible service (e.g., website) identify one or more “intersecting” stories, which are stories having metadata that “intersects” with the intersection criteria. For example, the intersecting stories may include stories that have time and location metadata that “overlaps” with the time and location of the intersection criteria. The stories may be presented to the user in an interface and may be ordered based on a relevance metric (discussed below).

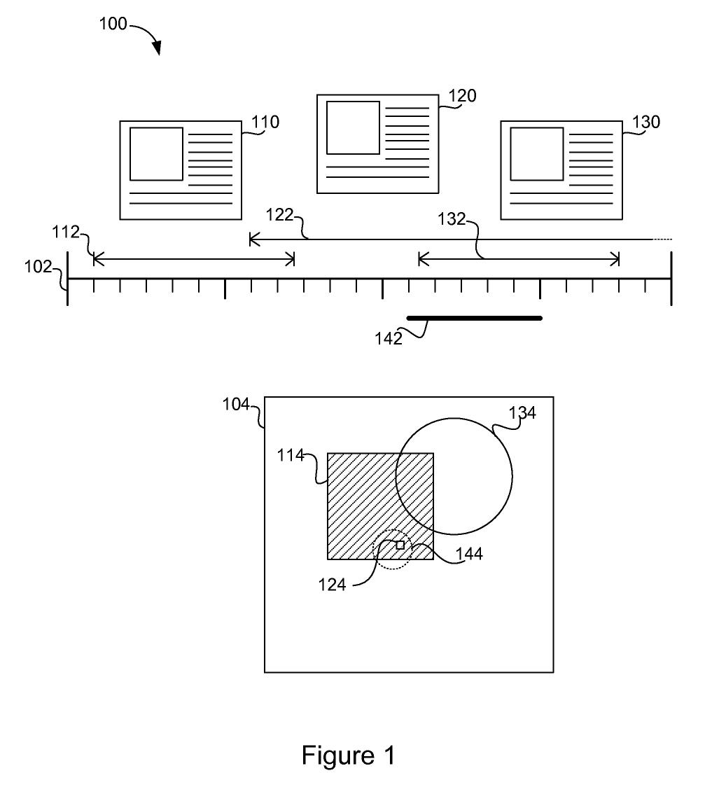

FIG. 1 depicts one example of a timeframe and location intersection. Metadata associated with the stories 110, 120, and 130 are depicted on an exemplary chronology 102 and location map 104. A first story 110 is associated with a first timeframe 112 and a first location 114, a second story 120 is associated with a second timeframe 122 and a second location 124, and a third story 130 is associated with a third timeframe 132 and third location 134. The timeframe 120 is open ended (has not been assigned an end point). The location metadata of the stories may be defined at different granularities; for instance, the location 124 of the story 120 may be defined relatively specifically (e.g., as a particular address), whereas the locations 114 and 134 may include broader regions (e.g., a block, subdivision, city, etc.).

The intersection criteria may be expressed as a timeframe 142 and location 144. Like the locations 114, 124, and/or 134, the location intersection criteria 144 may be specified with varying specificity; the criteria 144 may be expressed as a location “point” (e.g., an address or location coordinate) or as a larger region. Stories having metadata that overlaps the intersection criteria 142 and 144 may be identified as “intersecting” stories (or TL intersecting stories).

In the FIG. 1 example, the story 120 may be identified as an “intersecting” story. The timeframes 122 and 132 intersect with the timeframe intersection criteria 142, and the locations 114 and 124 intersect with the location intersection criteria 144; only story 120 intersects with respect to both time 142 and location 144.

In some embodiments, the intersection criteria 142 and 144 may be dynamically modified by the user. For instance, a user may expand or shift the timeframe 142 of the intersection criteria to overlap the timeframe 112, which may cause the story 110 to intersect with the modified intersection criteria 142 and 144. Similarly, the user may expand or shift the location portion 144 of the intersection criteria to overlap the location 134, which may cause the story 130 to intersect with the modified intersection criteria 142 and 144.

In some embodiments, the timeframe and/or location (or other metadata) of a particular story (e.g., story 110) may be used to identify other intersecting stories. In the FIG. 1 example, the stories 110 and 120 may intersect with one another with respect to time and location, since their timeframe 112, 122 and location 114, 124 metadata overlap. Intersections between stories may be identified by deriving intersection criteria from a first story (e.g., story 110), and using the derived intersection criteria to identify other, intersecting stories (e.g., story 120). As will be discussed below, story-to-story intersections may be used to identify shared interests between users and/or to aggregate stories related to similar events.

Although FIG. 1 describes intersection criteria based on a timeframe and location (“TL intersection criteria”), the disclosure is not limited in this regard. For example, TL intersection criteria may be combined with other metadata criteria to “filter” the intersecting stories. The criteria may be based on any type of story metadata including, but not limited to: story participant(s), story contributor(s), descriptive tags, interested person(s), story type, importance, story ratings (a metric quantifying a “quality” of the story or contributor), and so on. For instance, TL intersection criteria may be combined with descriptive tag criteria to identify a subset of the intersecting stories that relate to a particular event (e.g., are tagged with a particular descriptive tag). For example, TL intersection criteria may be combined with a “soccer” tag to identify stories related to soccer games that took place at a particular time and location.

Other types of intersection criteria may be predicated upon other types of metadata. For example, timeframe and contributor intersection criteria (“TC intersection criteria”) may be used to identify the stories contributed and/or “borrowed” by a particular user during a particular timeframe (story borrowing discussed below). In another example, timeframe and participant intersection criteria (“TP intersection criteria”) may be used to identify stories in which a particular user was a participant during a particular timeframe. As could be appreciated by one of skill in the art, the teachings of the disclosure could be adapted to use virtually any combination of metadata to identify and/or filter intersecting stories.

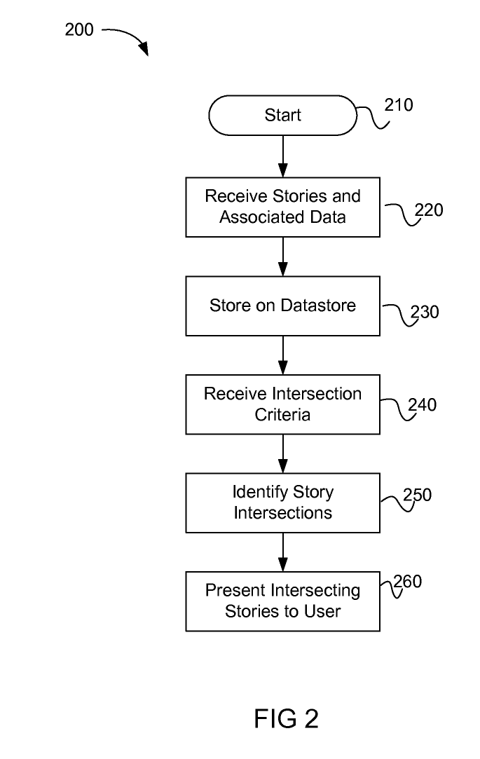

FIG. 2 is a flow diagram of one embodiment of a method 200 for identifying stories using intersection criteria. At step 210, the method 200 may be initialized as described above.

At step 220, one or more stories and associated metadata may be received. Each of the stories received at step 220 may comprise one or more content items and associated metadata, such as a timeframe, location, participants, contributor(s), descriptive tags, and so on. The stories may have been contributed and/or authored using an interface provided by a network-accessible service (e.g., website), such as the interface 100 of FIG. 1A.

At step 230, the one or more stories (and associated metadata) may be stored on a datastore (e.g., database, directory, or the like) and made available for access by users via a network, such as the Internet. In one example, one or more of the stories may pertain to a youth sporting event. The stories may include photographs of the participants, which may be of interest to other event attendees.

At step 240, intersection criteria may be received. The intersection criteria may comprise a timeframe and location (e.g., may be TL intersection criteria). The intersection criteria may be received from a user via a user interface (e.g., via the interfaces 300 and/or 303 described below in conjunction with FIGS. 3A and 3B). The timeframe of the intersection criteria may comprise a chronological range having a starting point (start time) and/or an ending point (ending time). The location of the intersection criteria may identify a location or region of interest. The location may identify a “real-world” location (e.g., an address, set of coordinates, etc.) or “virtual” (a location in a virtual space, a mobile location, an alias, or the like). The location may be specified at varying levels of detail or specificity (e.g., as a particular address, a block, a neighborhood, a region, and so on).

Continuing the example above, the intersection criteria received at step 240 may be provided by a user interested in the youth sporting event. Accordingly, the intersection criteria may identify the timeframe and location of the event (e.g., Apr. 12, 2008, from 2:30 PM to 4:40 PM at Smith Park).

At step 250, the method 200 may query the datastore to identify stories that intersect with the timeframe and location of the intersection criteria. Continuing the youth sporting event example, the intersecting stories identified at step 250 may comprise the stories available to the method 200 (e.g., stored in the datastore) that occurred within the specified location (e.g., Smith Park) during the specified timeframe (Apr. 12, 2008 2:30 PM to 4:40 PM).

Step 250 may further comprise filtering the intersecting stories. As discussed above, intersection criteria may include additional constraints, which may be used to “filter” intersecting stories. For example, to find intersecting stories related to the youth sporting event, the stories may be filtered using a “soccer” descriptive tag, a “participant” filter may be used to identify the stories in which a particular user appears, and so on.

At step 260, the stories identified at step 250 may be presented to the user in an interface. The results may comprise a list of stories that intersect with the provided intersection criteria and/or satisfy one or more additional filter constraints. In some embodiments, the results may be ordered relative to one another in the interface, such that the stories that are most likely to be of interest to the user are more prominently displayed (e.g., displayed near the head of the list or stories). Examples of systems and methods for ordering intersecting stories are discussed below.

Although FIG. 2 describes identifying intersections with respect to timeframe and location, the disclosure is not limited in this regard; the teachings of the disclosure could be used to identify intersections of any type. For instance, timeframe-contributor intersection criteria may be used to identify stories contributed and/or borrowed by a particular user during a particular timeframe, timeframe-participant intersection criteria may be used to identify stories in which a particular user appears, and so on.

The intersection criteria described above may be used to define an “intersection space.” As used herein, an “intersection space” may refer to a “virtual companion space” that may aggregate content that intersects with a particular set of intersection criteria. Accordingly, an intersection space may refer to a particular junction of timeframe and location, such as Apr. 12, 2008, from 2:30 PM to 4:40 PM and “Smith Park.” An intersection space may act as a “home page” to document activities occurring at the park during the specified timeframe. Of course, an intersection space may be defined more broadly. For example, an intersection space may be defined along a very long timeframe (e.g., unlimited timeframe) to chronicle the history of a particular location (e.g., chronicle the history of a particular building or institution). Different levels of metadata specificity may determine which stories are included in an intersection space and how the stories are displayed and/or ordered therein.

In one illustrative example, a contributor may create a story regarding a trip to the summit of Mt. Rainier on Jul. 10, 2003, at 10:15 AM. The timeframe of the story may include the short time the contributor actually spent on the summit (e.g., 30 minutes), may comprise the entire day of the hike, or some other timeframe (e.g., the weekend of the trip, the month of July 2003, the season, and so on). Similarly, the location of the story may be provided at varying levels of specificity; the location may be the summit area itself, the area traversed during the summit approach, the mountain range, the entire state of Washington, and so on.

The timeframe and/or location metadata assigned to the story may determine what other stories will intersect with the story's intersection space. For example, if the contributor assigns the “30-minute” timeframe to his story, the story may not intersect with the story of another hiker who summited Rainier at 1:20 PM on the same day (and specified a similarly specific timeframe for his story). If the contributor were to specify a broader timeframe, however, such as the entire month of July 2003, the intersection space of the contributor's story may include other stories occurring during the month of July 2003, including the story of the 1:20 PM summit.

The location metadata may similarly define the scope of the intersection space. For instance, if the contributor were to specify the location of his story as a small area in the vicinity of the summit, the story may not intersect with the story of another hiker who stopped short of the summit (and specified a similarly narrow location). If the contributor used a broader location, such as the entire mountain range, the resulting intersection space would include other hikes to the summit, as well as other experiences that may be unrelated to a summit attempt.

As discussed above, in some embodiments, the location of a story may be “virtual,” such as a location within a MMOG, a cruise ship, a business name, or the like. For example, an intersection space of a restaurant may chronicle the events occurring at the restaurant despite the fact that the restaurant may have changed locations several times during its history. Since the intersection space is defined with respect to the restaurant as opposed to a particular location or address, the intersection space may “follow” the restaurant as it moves from place to place. Similarly, an intersection space specified with respect to a particular cruise ship may “follow” the cruise ship's movements (may be referenced by name as opposed to a particular, “real-world” location).

An intersection space may be specified with respect to other types of intersection criteria, such as story contributors, story participants, and the like. For example, an intersection space may chronicle the stories involving a particular set of participants during a particular timeframe (e.g., the stories involving a youth soccer team). As will be discussed below, these types of intersections may be formed into a “story line,” which may chronicle a particular set of related stories. The intersection space of a particular contributor may comprise all the stories contributed (or borrowed) by the contributor over his/her lifetime. Accordingly, a contributor intersection space may represent the lifetime “storyline” of a particular user.

Like the story content and metadata discussed above, an intersection space may be submitted to a network-accessible service (e.g., website) and stored on a datastore thereof (e.g., database, directory, or the like), which may provide an interface (e.g., a webpage) to display intersection spaces. For example, the network-accessible service (e.g., website) may provide an interface dedicated to the intersection space of the summit of Mt. Rainier and the month of July 2003. The intersection space interface may act as a repository of the stories related to a particular time and place. Alternatively, or in addition, an interface through which users may dynamically determine an intersection space may be provided (e.g., interface 300 of FIG. 3A discussed below).

FIG. 3A depicts one embodiment of an interface for selecting and displaying an intersection space. The interface 300 may be provided by a network-accessible service, such as a website, for display on a user computing device. In some embodiments, the interface 300 may be provided in a browser-renderable format, such as Hypertext Markup Language (HTML) or the like. Accordingly, the interface 300 may be displayed within a window 302 of a browser application 301. Alternatively, or in addition, the interface 300 may be adapted for display in a stand-alone application, as a plug-in to another application, or the like.

The interface 300 may include a timeframe control 310, upon which a timeframe indicator 312 may be manipulated to dynamically select a timeframe of interest (to select the prevailing timeframe 312). The timescale (or time span) covered by the timeframe control 310 may be shown by timeframe indicators 313, which, in some embodiments, may comprise labels identifying the year, month, day, hour, or the like, currently displayed in the timeframe control 310. In alternate embodiment, the labels could indicate the age of an individual, institution, event, or other storyline (discussed below). The timeframe control 310 may include a time scale input 314, which may be used to selectively increase or decrease the time scale of the timeframe control 310. For example, a user may use the input 314 to “zoom in,” until the control 310 spans only few seconds, or “zoom out” until the control 314 spans a series of decades. As illustrated in FIG. 3A, the timeframe 312 may specify a start time and an end time. In other embodiments, however, the timeframe 312 may be manipulated such that there is no pre-defined start or end time. At the start and/or end points, the control 310 may comprise timeframe browsing inputs 316a and 316b, which may allow a user to shift the timeframe control 310 forward or backwards in time, respectively.

In some embodiments, the timeframe control 310 may include a “story indicator” region 317, which may comprise one or more indicators 318 of stories that intersect with the timeframe selection 312 (and other intersection criteria, such as location 320 and the like). As will be discussed below, the region and/or indicators 318 may be configured to display stories according to relative importance, density, “heat” (relative rating), and so on.

Although a timeframe control is depicted in FIG. 3A (and FIG. 3B), the interface 300 is not limited in this regard; other timeframe inputs could be used under the teachings of this disclosure, such as text input fields, clock controls, calendar controls, or the like. The timeframe control 310 (or other timeframe control element) may reference an absolute time, a virtual time, or a relative time (including an age or duration). For example, the start time of the control may be specified using an alias (e.g., the day the contributor was born), and the timeframe control 310 may display times as an offset from the relative time. In this way, a contributor may hide his/her real age, while allowing users to browse his stories chronologically.

A location control 320 may be used to specify a location of interest 322. The location may be specified with respect to a single point (or address) 322 or as an area or region 323. The control 320 may include a location scale control 324, which may be used to change the scale of the map 320 (to “zoom in” to a particular neighborhood or “zoom out” to a state, country, or continent). Although a map 320 is depicted in the interface 300, the interface 300 is not limited in this regard; other inputs could be used under the teachings of this disclosure. For example, a text input could be used to enter address or coordinate information. The locations may be in the “real-world” or within a virtual location namespace. Accordingly, in some embodiments, a “virtual” address namespace or map could replace a “real-world” map, and so on.

The timeframe and location information provided via the controls 310 and 320 may define intersection criteria, which may be used to identify an intersection space. The timeframe of the intersection space may be the timeframe 312 specified using the timeframe control 310, and the location of the intersection space may be the location or region entered via the location control 320. The interface 300 may display indicators of the stories that intersect the intersection space in a display region 330. The intersecting stories may be identified as described above in conjunction with FIGS. 1 and 2 (e.g., by comparing timeframe, location, and/or other story metadata to the intersection criteria provided via the interface, such as the timeframe 312 and/or location 322 or 323). As will be described below, the stories in the region 330 may be ordered according to which stories are likely to be of the most relevance to the user.

In some embodiments, the interface 300 may include a title 328. The title 328 may be predetermined. For example, if the interface 300 is configured to display a particular intersection space (e.g., the history of a location), the title may be the name of the location. For dynamically selected intersection spaces, such as the intersection space depicted in FIG. 3A, the title 328 may be determined based upon the content of the intersecting stories. For example, the title 328 may be selected from a set of prominent descriptive tags associated with the stories in the intersection space (e.g., if the story tags are predominantly “summer” and “vacation” the title 328 may be set to “summer vacation”). An example of a “dynamic tag cloud” is described below in conjunction with element 346.

Stories may be displayed within the region 330 in various ways. In some embodiments, stories may be displayed in a “link badge” format. The link badge format of a story 332 may include a scaled image 333 of the story, a story title 334, a byline 335 indicting the story contributor, a text selection 336 from the story 332, an intersection indicator 337, and so on. The intersection indicator 337 may identify the intersection criteria used to include the story 332 in the intersection space (e.g., identify the timeframe and/or location of the story 332). As discussed above, the content of the link badge elements 333, 334, 335, 336, and/or 337 (and/or other link badge elements, not shown) may be automatically selected from the story content and/or may be authored by the story contributor. In other embodiments, the interface 300 may display the stories 330 in different ways (e.g., a list), a set of thumbnails, or the like. Therefore, the interface 300 should not be read as limited to any particular way of displaying story indications.

The interface 300 may further comprise one or more metadata display and/or filtering elements, which may be used to display story metadata and/or “filter” the stories in the intersection space (filter the stories included in the region 330). In the FIG. 3A example, the interface 300 includes a contributor element 340, a participants element 342, an interested persons element 344, a story type element 346, a descriptive tag element 348 (e.g., dynamic tag cloud), and a rating element 350. The interface 300, however, is not limited in this regard and could be extended to include any number and/or type of filtering controls configured to filter the intersection space based on any type of story content and/or metadata.

The contributor element 340 may filter stories based upon the story contributor. In some embodiments, the contributor element 340 may be populated with indications the contributors of the stories in the intersection space. The contributor indications may include a count of the number of stories submitted by each contributor. Selection of a particular set of one or more contributors 341 may filter the intersection space, such that only stories submitted by the specified contributors 341 are included therein, stories contributed by other, unselected contributors may be removed.

A participants element 342 may be provided to filter the intersection space based upon which participants appear therein. The participants element 342 may be pre-populated with a union of the participants of all the stories in the intersection space. The participant indicators may include a count (or other indicator) of their respective prevalence in the intersecting stories. The intersection space may be filtered to include only those stories that include a particular set of one or more participants 343. The interface may further comprise an interested persons element 344, which may operate similarly to the participants element 342 (e.g., may display a union of the interested persons associated with the stories in the intersection space and/or provide for filtering of the intersection space by selected interested persons 345).

In some embodiments, the interface 300 may include a story type element 346, which may filter the intersection space by story type. The story type element 346 may be pre-populated with indications of the story types of the stories in the intersection space. The story type indicators may include respective counts indicating how many stories of each type are in the intersection space. Selection of one or more story types 347 may filter the intersection space by story type; only stories of the selected story type(s) 347 will remain in the intersection space.

In some embodiments, the interface 300 may include a descriptive tag element (dynamic tag cloud) 348, which may be pre-populated with a “dynamic tag cloud” of the intersecting stories; the dynamic tag cloud may comprise a “union” of the descriptive tags of the stories in the intersection space and included in the region 330. A tag may be expressed in language, pictures, a combination (picture(s) and language), or the like. The dynamic tag cloud displayed in the element 348 may indicate the relative tag prevalence. For example, tags that appear in many different stories may be displayed prominently (e.g., in a large, bold font), whereas tags other tags may be less prominently displayed (e.g., in a smaller font). Alternatively, or in addition, a story count may be displayed in connection with each tag. The user may select one or more tags 349 in the descriptive tag input 348 (or tag cloud) to cause only stories that have the selected tags 349 to be included in the intersection space.

The interface 300 may include a rating element 350 configured to filter the intersecting stories by rating, regardless of whether the rating is expressed explicitly. The rating element 350 may be pre-populated with an indicator of an average or mean or other rating of the stories in the intersection space. The user may set a rating threshold 351, and any stories that fall below the threshold may be filtered from the intersection space.

As described above, the controls 310 and 320 may be manipulated to dynamically modify the intersection criteria of the intersection space, which, in the FIG. 3A example, is timeframe and location. Accordingly, as a user manipulates the controls 310 and/or 320, the stories included in the intersection space may change and/or the relative ordering of the stories in the region 330 may change. Other elements of the interface 300 may similarly change. For instance, the contributor element 340 may be re-populated to reflect changes to the intersection space (e.g., remove indicators of contributors whose stories are no longer in the intersection space, update contributor counts, add new contributors, and so on). The participants element 342, interested persons element 344, story type element 346, descriptive tag element 348 (dynamic tag cloud), rating element 350, and/or other elements (not shown) may be similarly updated. For example, as the stories in the intersection space change, the tags in the tag cloud displayed in the descriptive tag element 348 may be updated (added, removed, etc.). Likewise, the relative prominence of the tags may change; for instance, a “skiing” tag (e.g., skiing) which was prominent during a winter timeframe may become less prominent when the timeframe is shifted into the summer.

The timeframe control 310 of the interface 300 may provide an “inverted tag cloud” display 352. The inverted tag cloud 352 may display a set of tags associated with a selected region of the timeframe control 310. For example, the user may hover an interface cursor 305 over a particular location on the timeframe control 310. The hover location may specify a particular timeframe within the timeframe control 310. When the cursor is “hovered” for a pre-determined time, the inverted tag cloud display 352 may be shown. The inverted tag cloud display 352 may comprise the descriptive tags of stories (if any) having a timeframe that intersects and/or is proximate to the timeframe (in the timeframe control 310) over which the cursor 305 is hovering. A user may move the cursor 305 over the timeframe to see how the story tags change over time.

Frequently, an intersection space will be defined based on the combination of time and place assigned to a particular story; the user will be able to see other stories that happened at the same time and place as the particular story. Alternatively, or in addition, the user may manipulate the controls/elements 310, 320 and/or 342-350 to select an intersection space comprising stories related to a very specific event. For example, the user may be interested in accounts of a traffic accident. The user may manipulate the controls 310 and 320 to specify the timeframe and location of the crash. The resulting intersection space may include stories that are relevant to the accident (have intersecting timeframe and location metadata). The user may further refine the intersection space by selecting “accident” or “crash” descriptive tags in the descriptive tag element 348.

In another example, a user may define a broader intersection space in order to explore the character of a particular location, address, business, stories involving a particular set of participants, or the like. For instance, the user may want to investigate the “reputation” of a park to determine whether it would be a suitable place to take his child. In this case, the user may specify a large timeframe (the last decade) and may include a fairly large region (the park and surrounding neighborhoods). The user may further specify descriptive tags of interest, such as “crime,” “mugging,” and so on. The resulting stories may give the user an idea of how much crime has taken place in the area.

As discussed above, an intersection space may act as a “home page,” or “virtual companion space,” for a particular set of stories (e.g., stories sharing a common set of intersection criteria, such as timeframe and location). Therefore, in some embodiments, an intersection space interface, such as interface 300, may be fixed to particular intersection criterion. For instance, the network-accessible service (e.g., website) may provide an interface dedicated to chronicling the history of a particular location. The location control 320 of the dedicated interface may be fixed to the location of interest (e.g., park, hotel, etc.). The timeframe control 310 of the interface may remain dynamic or may be similarly restricted. For example, the starting time of the timeframe 312 of an interface dedicated to the history of a particular hotel may be limited to the date that construction on the hotel began. In another example, such as an intersection space dedicated to a youth sports team, the timeframe control 310 may be fixed to a particular range (e.g., the little league season), and the location control 320 may be fixed to particular location(s) (e.g., the venues where the team practices and plays). As would be appreciated by one of skill in the art, the teachings of this disclosure could be adapted to provide any number of dedicated intersection space interfaces directed to any number and/or type of intersection criteria.

In some embodiments, the network-accessible service (e.g., website) may provide an interface configured to display an intersection space dedicated to a particular contributor. The intersection space may comprise stories that have been contributed and/or borrowed by the contributor over a particular timeframe and, as such, may represent a life “storyline” for the contributor. The intersection space may further comprise stories in which the contributor has appeared as a participant and/or the contributor has expressed an interest. As will be described below, the contributor may “borrow” stories from other contributors, which may cause them to appear in the contributor's intersection space. Similarly, a user may be identified (tagged) as an “interested user” in one or more stories. The contributor may “borrow” these stories to include them the contributor's intersection space.

FIG. 3B depicts one embodiment of an interface 303 for displaying a contributor intersection space. In some embodiments, the interface 303 comprises a browser-renderable markup configured to be displayed in a window 302 of a browser application 301. However, as discussed above, the interface 303 is not limited in this regard and could be provided using any interface display and/or presentation mechanism known in the art.

The interface 303 includes a timeframe control 310, which, as discussed above, may be used to select a timeframe 312. Selection of the timeframe 312 may define a timeframe-contributor intersection space (TC intersection criteria). Indications of the stories that intersect with the TC intersection criteria may be displayed in region 330 (in a link badge format 332). The interface 303 may further comprise one or more metadata elements, which may be used to display and/or filter the intersecting stories according to story metadata, such as story contributor 340, story participants 342, interested persons 344, story type 346, descriptive tags 348, rating 350, and so on. Although not shown in FIG. 3B, the interface 303 may include a location input or display (like the location input 320 of FIG. 3A), which may be used to identify a location of interest (to define a timeframe-contributor-location intersection space). The intersection space interface by comprise a title 328 identifying the contributor (“e.g., Peter's Life”).

The interface 303 may further include a context pane 360. The context pane 360 may comprise a “tab” (or other interface element) configured to display a chronological profile 362 of the contributor. As discussed above, a user profile under the teachings of this disclosure may include chronologically-tagged profile information (profile information may be associated with a particular timeframe). Therefore, unlike traditional user profiles that provide only an “instantaneous” picture of the user, the user profiles taught herein may provide a user profile chronology. For example, a user profile attribute, such as marital status, may be different at different times of a contributors life; the contributor starts out as “single,” gets married in 1994, is divorced in 1998, and is remarried in 2004. The marital status of the user may include each of these attributes (single, married, divorced, remarried), each associated with a respective timeframe. Other “milestone” type life events, such as educational status, employment status, and the like, may be similarly tied to a chronology. For example, chronological profile attributes may show the progression of the contributor's musical or artistic taste over time. User-defining information, such as a “motto,” favorite quote, or the like, may be tied to a chronology as may the contributor's physical attributes (height, weight, health, chronic disease, etc.). For example, the user may indicate that from 2003 to 2005 he/she was “fighting cancer,” and from 2006 onward is a “cancer survivor.” The user profile may comprise a plurality of contributor avatars, each associated with a different respective timeframe. Accordingly, the profile photos may illustrate changes in the appearance of the contributor over time. As used herein, an avatar may refer to any depiction of a user (graphical or otherwise). Therefore, an avatar may refer to a photograph, a caricature, a drawing or illustration, a video clip, renderable content, or the like.

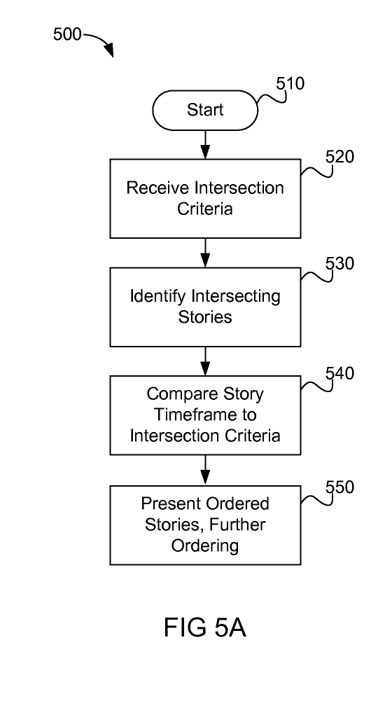

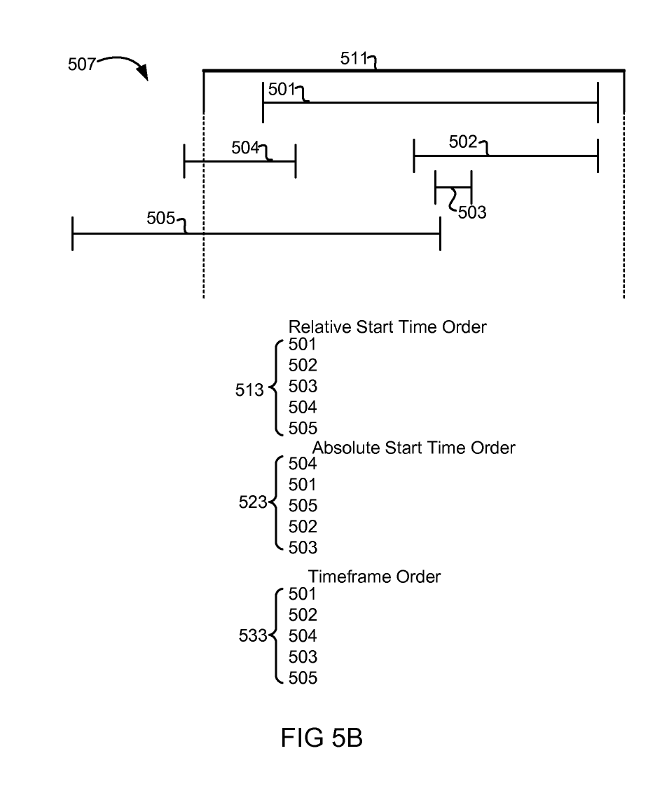

The chronological profile 362 may include a timeframe indicator 364 that shows the relevant time period covered in the profile 362 (from Apr. 4, 2005, to Oct. 3, 2005). The timeframe indictor 364 may correspond to the timeframe 312 of the timeframe control 310. The contents 366 of the chronological profile 362 may comprise the profile entries that “intersect” with the timeframe 364 (attributes that were valid during the specified timeframe 364). The content 366 may include the profile photo that corresponds to the timeframe 364. If multiple attributes are valid during the timeframe 364, each valid attribute may be displayed (e.g., marital status may display as married, divorced (on date)). Alternatively, only the “most recent,” “least recent,” “most prevalent,” or similar profile attribute may be displayed (as determined automatically or by the user). For example, if the contributor was married on the last day of a three-month timeframe 364, marital status may be “married.” Alternatively, since during most of the timeframe 364 the contributor was single, the status may indicate “single.” The disclosure contemplates many different mechanisms for selecting and/or prioritizing chronological information (e.g., method 500 of FIG. 5A) and, as such, this disclosure is not limited to any particular technique for selecting chronological profile information.

The context pane 360 may further include an age display element (as a “tab” or other interface element) 370. Therefore, although the age display element 370 is shown as a separate component (window), it may be included as selectable tab of the context pane 360. The age display element 370 may be configured to display a chronologically comparison between the contributor's life to the life of another user (or prominent person). The “age” used for comparison purposes may be the age of the contributor at the timeframe 312 specified in the timeframe control 310. The age display element 370 may include an indicator 372 of the relevant time period, which may comprise the comparison age discussed above. The age display element 370 may compare the stories and/or profile information of the contributor at the identified age to stories and/or profile information of another user. Accordingly, the chronological context of the other user may be “shifted” to correspond to the contributor's age. For example, the life events of Abraham Lincoln may be “time shifted” to correspond to the chronology of the contributor. Relevant results may be presented in a display area 374. For example, if the contributor is age 22 in the timeframe 372, contributor's profile and/or stories may be compared to Abraham Lincoln's life events at age 22 (at age 22 Abraham Lincoln struck out on his own, canoeing down the Sangamon River to New Salem). This information may be juxtaposed to the contributors profile information; for example, the contributor may have recently graduated from college and is moving to a new town for his/her first job. It would be understood by one of skill in the art that any manner of age- or chronology-based comparisons could be included in the age display element 370.

The context pane 360 may further include a general context display element (as a “tab” or other interface element) 380. Therefore, although the age display element 380 is shown as a separate component (window), it may be included as selectable tab of the context pane 360. The general context display element 380 may include a timeframe indicator 382, which may correspond to the timeframe control 310, 312. A display area 384 of the element 380 may include general context information relevant to the indicated timeframe 382. The display area may include newsworthy events, top songs (including “listen” or “purchase” links), what other “notable lives” were doing at the time, what members of the contributor's circle were doing, and so on.

As discussed above, a contributor may “borrow” stories from other contributors. In some embodiments, a contributor may be a tagged as a participant and/or as an “interested person” in a story contributed by another user. The contributor may be informed of the story (via a message, a display element, or the like), and may be given the opportunity to accept or reject the tag. In addition, the contributor may be prompted to view and/or “borrow” the story. As will be discussed below, rejecting a “participant” or “interested person” tag may cause the contributor to be removed from the story metadata (e.g., be unlinked from the story), accepting the tag may cause the contributor to be associated with the story (e.g., be displayed in “participant” or “interested person” story metadata, and so on). Borrowing the story may cause the story to be included in the contributor's intersection space. Accordingly, the story may appear with other stories contributed by the contributor. When a story is borrowed, the borrower may specify access controls for the story, as if the story where contributed and/or authored by the contributor. The contributor may specify that the story is to be available publically or only within one or more circles. Accordingly, access to a story may be predicated on a “multi-tiered” system. A first tier may be determined by the original story contributor (e.g., whether the participants may have access to the story). The story participants that borrow the story may include their own set of access controls (e.g., additional tiers of access). For example, the original contributor may specify that a story is to be accessible to his “family” circle. A user who borrows the story may choose to publish the story to a different group of people (e.g., his “friends” circle).

Multi-tiered access control may be leveraged to publish stories in a “mixed trust” environment. For example, a group of parents whose children play on the same soccer team may not have personal relationships with one another; they may, however, have a trust relationship with the coach. The parents may choose to restrictively share stories related to the soccer team with the coach, who may “borrow” the stories. The coach, who has a trust relationship with the other parents, may publish the stories to a “parents” circle. In this way, all of the parents may get access to soccer-related stories, while preserving their individual privacy (and without individually establishing trust relationships with each of the other parents).

The original contributor of a story may control how certain story information is disseminated in the multi-tiered access scheme described above. For example, the original contributor may refer certain story metadata (timeframe and/or location) using aliases. The “actual” data associated with the aliases may be available only to the user's “friends” circle. Therefore, even if a friend publically shares a story, other users accessing the story may not have access to the underlying timeframe and/or location information.

In some embodiments, the original story contributor may have additional controls over story sharing. For example, the user may not allow the story to be borrowed and/or the user may define to whom the story may be accessible. These types of access controls may be tied to the story, to prevent the story from being made available outside of a specified group of people (outside of a specified circle).

As illustrated above in FIGS. 3A and 3B, an intersection space may include a plurality of intersecting stories (displayed in the region 330). The story indications displayed in the region 330 may be ordered according to the likelihood that the story will be relevant to the user. Stories considered more “important” (relevant) to the user may be displayed more prominently within the region 330 (e.g., at the head of a list, in a larger, bold font or the like). The likelihood that a story is relevant may be based on comparisons between the story metadata and the intersection space criteria and/or metadata filters.

FIG. 3C depicts one embodiment of an interface 304 for displaying a story. The interface 304 may be accessible via the interfaces 300 and/or 303 by, inter alia, selecting a story displayed in the region 330. The interface may display story content, such as a story title, text (in text display area 308), story images, or other content items (e.g., video, audio, etc), including a currently selected or highlighted content item 309 as well as “thumbnail” indicators 311 of other story items. In some embodiments, the interface 304 may include a video player component (not shown), an audio player component (not shown), or the like.

The interface may identify the story contributor in a byline display 306. The byline may display a profile avatar (photo) 307 of the contributor. The byline display 306 may comprise a link to an interface configured to display other stories of the contributor (such as interface 303 discussed above). If the contributor specified an alias, and the viewer of the interface 304 is not authorized to access the contributor alias, the byline may not identify the user by his/her username, but instead an alias may be depicted and a different avatar 307 (if any) may be displayed. The link component of the byline 306 may link to stories submitted under the alias name (or the link may be disabled).

The interface 304 may display an intersection component 371, which may display metadata describing the story, such as a timeframe indicator 373 and/or a location indicator 375. The timeframe indicator 373 may be depicted on a timeframe control (not shown) as text (as in indicator 373), or the like. The story location metadata may be depicted on a map interface 375 (or in some other way, such as text, as a virtual location, an alias, or the like). The story location may be identified as a region and/or location point 377. The intersection component 371 may comprise a link 379 to access other items at the story intersection (e.g., to access stories that “intersect” with the story based on the story metadata, such as timeframe, location, participants, and the like).

If the story timeframe and/or location metadata are expressed as aliases, and the viewer of the interface 304 is not authorized to access the “actual value” of the aliases, the location and/or timeframe indicators 375 and/or 373 may be hidden or depicted as their “alias values.” Accordingly, the intersection link 379 may be disabled and/or may be directed to a limited set of stories having the same contributor alias.

The interface 304 may include a participants element 343, which may display indications of the story participants as identified by the story contributor (including the contributor, if applicable). The participant indicators 343 may comprise links to the respective participants' profiles (discussed below), or a link to an interface depicting the participants' stories (e.g., in an interface, such as the interface 303 discussed above). Interested persons indicators 345 may similarly display indications of the persons identified as being interested in the story. The interface 304 may include a story type element 347 to display the story type, and a descriptive tags element 349 may be to display the story tags.

In some embodiments, the interface 304 may comprise a comments display element 378, which may be configured to display user-submitted comments pertaining to the story. As will be discussed below, users identified as story participants and/or interested persons (in displays 343 and/or 345) may have a “right to comment” on the story. Comments submitted by story participants and/or interested persons may be prominently displayed in the element 378 (to prevent participant comments from being “drowned out” by other commentary). A comment input component 379 may be provided to receive user-submitted commentary.

A rating input and display element 390 may be provided to allow users to rate various aspects of the story. In some embodiments, the rating input 390 may comprise a multi-factor rating input. Examples of such inputs are described in U.S. patent application Ser. No. 12/539,789, entitled “Systems and Methods for Aggregating Content on a User-Content Driven Website,” filed Aug. 12, 2009, which is hereby incorporated by reference in its entirety. In some embodiments, the interface 304 may include a plurality of rating inputs 390, each adapted to rate a different aspect of the story (e.g., story content, story metadata, descriptive tags, etc.). In some embodiments, for example, users may rate the relevance of descriptive tags. Examples of such rating inputs are provided in United State patent application Ser. No. 11/969,407, entitled “Relevancy Rating of Tags,” filed Jan. 4, 2008, which is hereby incorporated by reference in its entirety.

In some embodiments, user ratings may be used to form an overall contributor rating, which may be displayed in connection with the contributor's profile. Examples of contributor rating indices and related displays are disclosed in U.S. patent application Ser. No. 12/540,171 which is incorporated by reference above. In some embodiments, the weight given the contributor's ratings of other user-submitted content may be based, at least in part, on the contributor's rating. Examples of systems and methods for calibrating user-submitted ratings are described in U.S. patent application Ser. No. 12/540,163, entitled, “Systems and Methods for Calibrating User Ratings,” filed Aug. 12, 2009, which is hereby incorporated by reference in its entirety.

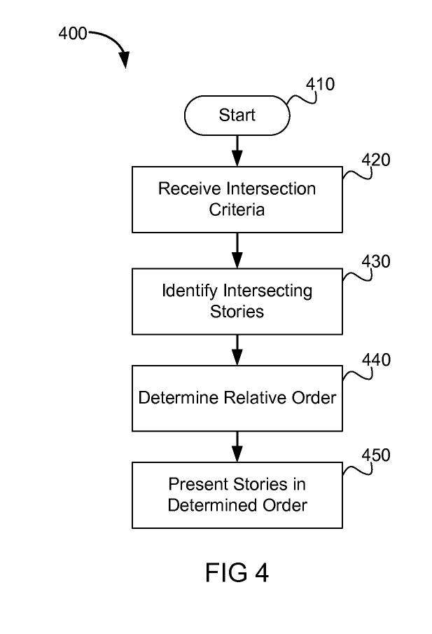

FIG. 4 depicts one embodiment of a method for prioritizing items presented in a chronology. For example, the method 400 may be used at step 260 of FIG. 2 to order a list of stories in an intersection space and/or to order the story indicators in the region 330 of the interface 300.

At step 410, the method 400 may be initialized as described above. Initializing may comprise accessing a datastore comprising a plurality of stories, each associated with metadata, such as a timeframe, location, and so on.

At step 420, intersection criteria may be received, and at step 430, the method 400 may identify a plurality of stories that intersect with the received intersection criteria. As discussed above, the intersecting stories may be identified by comparing metadata associated with the stories to the received intersection criteria. Step 430 may further comprise comparing the stories to one or more filters (e.g., descriptive tags, participants, etc.).

At step 440, the intersecting stories identified at step 430 may be assigned a relative order. The order may be determined by comparing the intersection criteria and/or filters to the story metadata. In some embodiments, each intersecting story may be assigned a respective “relevance” score. The relevance metric may quantify an empirically determined likelihood that the story will be relevant to a user viewing the intersection space. In some embodiments, the relevance metric may be determined by combining relevance metrics of different story metadata. For example, a story may be assigned a “timeframe” relevance metric, a “location” relevance metric, and so on, which may be combined into an overall relevance metric used to order the stories. The relative relevance metrics may be weighted with respect to one another. For example, the “location” relevance metric may be more heavily weighted in some situations than the “timeframe” relevance metric.

At step 450, the intersecting stories may be presented in a user interface in the order determined at step 440.

Although the method 400 is described as ordering stories (as are methods 500 and 600 discussed below), one of skill in the art would recognize that the chronological- and/or location-based ordering disclosed herein could be applied to any content item associated with chronological information. Therefore, this disclosure should not be read as limited to ordering only certain types of content.

FIG. 5A is a flowchart of one embodiment of a method 500 for ordering content chronologically. The method 500 may be used to determine a relative order of a plurality of stories in an intersection space and/or to assign a “timeframe” relevance metric thereto.

At steps 510, 520, and 530, the method 500 may be initialized, intersection criteria may be received, and a plurality of intersecting stories may be identified as described above.

At step 540, the timeframe of each of the stories may be compared to the intersection criteria timeframe (referred to as the “prevailing time”) to determine a relative ordering of the stories and/or to assign a timeframe relevance metric thereto.

In some embodiments, the stories may be ordered (or the “timeframe” score may be set) according to a “relative start time” metric. In this case, stories having a start time that is after the start time of the prevailing timeframe are ordered before stories having a start time that is before the start time of the prevailing timeframe. The stories that start after the prevailing timeframe are ordered chronologically (based on proximity to the prevailing start time). The stories that begin before the prevailing timeframe are ordered in reverse chronological order (again based on proximity to the prevailing start time).

FIG. 5B depicts one example 507 of story ordering using a “relative start time” metric. FIG. 5B depicts an intersection criteria timeframe (prevailing time) 511 and a corresponding set of intersecting stories 501-505. The timeframe of stories 501, 502 and 503 begin after the start time of the prevailing timeframe 511, and the timeframe of stories 504 and 505 begin before the time of the prevailing timeframe 511. Accordingly, stories 501, 502, and 503 will be ordered before stories 504 and 505. Stories 501, 502, and 503 are ordered chronologically with respect to one another, and stories 504 and 505 are ordered in reverse chronological order. The resulting order 513 and/or timeframe relevance metrics (from most to least relevant) is 501, 502, 503, 504 and 505.

In other embodiments, stories may be ordered according to an “absolute start time” metric. In this case, the stories may ordered according to the “absolute value” of the difference between story start time and prevailing start time regardless of whether the story start time begins before or after the prevailing start time. Referring to FIG. 5B, the order 523 using “absolute start time” is 504 (since it is the most proximate to the prevailing start time 511), 501, 505, 502 and 503.

In other embodiments, a timeframe correspondence metric may be used. The timeframe correspondence metric may quantify how closely the prevailing timeframe corresponds to the timeframe of a story. The timeframe correspondence may be determined as a sum (or other combination) of an absolute value difference between the story start time and prevailing start time and the story end time and prevailing end time. Referring to FIG. 5B, order 533 according to the timeframe correspondence metric begins with story 501, which most closely corresponds to the intersection criteria timeframe followed by 502, 504, 503, and 505.

Referring back to FIG. 5A, although method 500 is described using a particular set of exemplary timeframe comparison techniques, one of skill in the art would recognize that method 500 could be extended to incorporate any time and/or timeframe comparison technique known in the art. Therefore, method 500 is not limited to the exemplary timeframe comparisons disclosed above.

After the timeframe ordering of the stories is determined and/or a timeframe relevance metric is assigned to each of the stories, the flow may continue to step 550 where the ordered stories may be presented to a user in an interface and/or additional ordering processing may occur (e.g., at step 440 of FIG. 4).

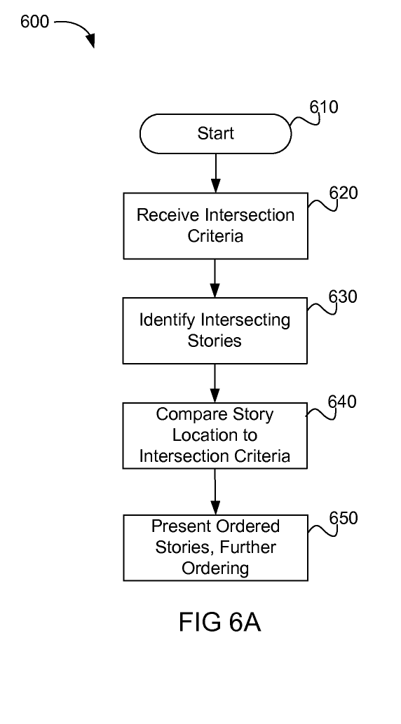

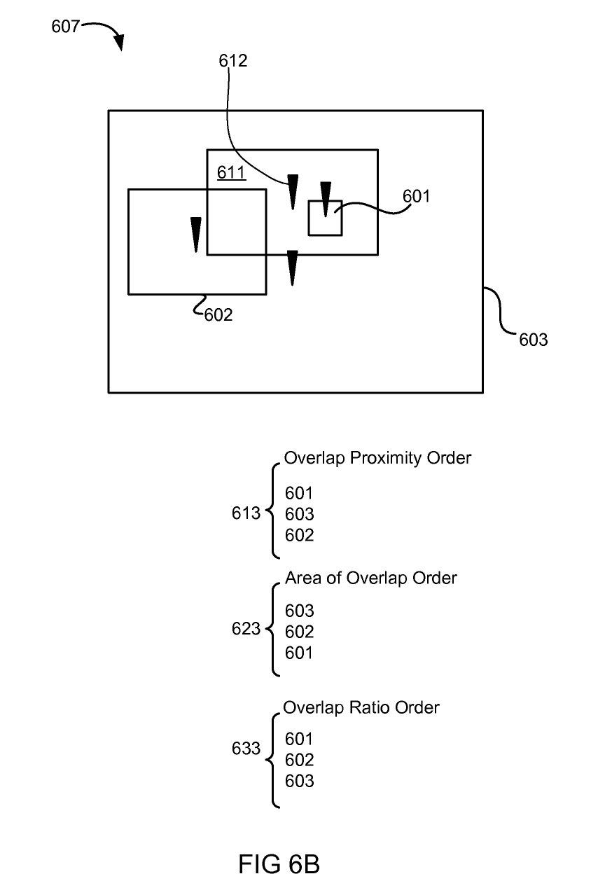

FIG. 6A is a flowchart of one embodiment of a method 600 for ordering content by location. The method 600 may be used to determine a relative order of a plurality of stories in an intersection space and/or to assign a “location” relevance metric thereto.

At steps 610, 620, and 630, the method 600 may be initialized, intersection criteria may be received, and a plurality of intersecting stories may be identified as described above.

At step 640, the location of each of the stories may be compared to the intersection criteria location (referred to as the “prevailing location”) to determine a relative ordering of the stories and/or to assign a location relevance metric thereto.

In some embodiments, the stories may be ordered (or the “location” score may be set) according to a “proximity” metric. In this case, stories may be ordered according to the proximity of the “center” of the story location to the “center” of the intersection criteria location. As used herein, the “center” may refer to a particular point location within a region (e.g., the center of a circle or square region). If a location is specified as a particular point or address, the “center” is the particular point or address.

FIG. 6B depicts one example 607 of center ordering. The intersection criteria may include a region 611 having a center 612. Stories 601, 602, and 603 may be ordered 613 (or location score assigned) based the proximity of each story location center to the center 612. The story 601 is most proximate to the center 612 and, as such, is ordered first, followed by 603 and 602.

In other embodiments, stories may be ordered according to an “area of overlap” order 623, which corresponds to the area of overlap between the intersection criteria location 611 and the story locations. Referring to FIG. 6B, the story 603 completely overlaps the intersection criteria location 611 and, as such, is ordered first, followed by 602 and 601.

In other embodiments, stories may be ordered according to the ratio of story location area to the area of overlap between the story location and intersection criteria location. Under this metric, stories that have extremely broad locations may be ordered lower than stories that have an area that more closely resembles the intersection criteria area. Referring to FIG. 6B, the story 601 may be placed first in the order 633 since it has a high ratio of overlap area to total area (1 to 1), story 602 is ordered next, and story 603, which has an extremely broad location, is ordered last.

Referring back to FIG. 6A, although method 600 is described using a particular set of exemplary location comparison techniques, one of skill in the art would recognize that method 600 could be extended to incorporate any location and/or region comparison technique known in the art. Therefore, method 600 is not limited to the exemplary location comparisons disclosed above.

After the location ordering of the stories is determined and/or a location relevance metric is assigned to each of the stories, the flow may continue to step 650 where the ordered stories may be presented to a user in an interface and/or additional ordering processing may occur (e.g., at step 440 of FIG. 4).

As discussed above, the order in which stories appear in an intersection space may be determined by comparing the story timeframe to the prevailing timeframe of the intersection space. Timeframe information may also be used to maintain the visibility of important stories within a prevailing timeframe. As used herein, an “important” story may be a story that is likely to be highly-relevant and/or of interest to a user. Maintaining the visibility of an important story may comprise placing important stories at the head of a story list (e.g., region 330 if FIGS. 3A and 3b), prominently displaying the important stories, filtering “unimportant stories” from the intersection space, or the like.

A timeframe selection control, such as the control 310 of FIGS. 3A and 3B may be scalable; a user may “zoom in” to view a detailed timeframe spanning a single day, hour, or a minute, or “zoom out” to view a timeframe that spans a significantly longer timeframe (e.g., months, years, decades, etc.) As the user “zooms out” and/or otherwise increases the size of a prevailing time, more items may be included in the resulting intersection space. Conversely, when the user “zooms in,” a smaller number of stories may intersect the prevailing time. In either case, it may be important to highlight “important” stories within the prevailing timeframe that are likely to be of interest to the user.

The identification of important stories may be similar to a “level of detail” interface on a map. The information displayed on the map may be appropriate to the map scale. When the view of a map is zoomed out, low-level details, such as city names, local roads, and the like are hidden (since their inclusion would render the map unreadable), and higher-level features are displayed, such as state lines, major roadways, and the like. Conversely, when a user zooms in, the display may replace the higher-level features with more detailed features, such as city names, county lines, and the like in accordance with the more detailed map scale.

A similar phenomenon may occur as a user explores the intersection space of particular stories. As discussed above, a user may browse chronological content (stories) using intersection criteria, such as a particular timeframe of interest (also referred to as a “prevailing timeframe” or more generally as “intersection criteria”). The stories in an intersection space may be “filtered” by their relative importance. In some embodiments, important stories may be included in a particular results set or displayed in an interface, while other, less important stories may be excluded. The relative importance of an item within a prevailing timeframe may be quantified by, inter alia, comparing a timeframe associated with the item to the prevailing timeframe. When there is a high correlation between a scale of the item's timeframe and the scale of the timeframe of interest, the item may be identified as potentially important. Conversely, when the scale of the item's timeframe and the prevailing timeframe differs, the item may be considered to be less important.

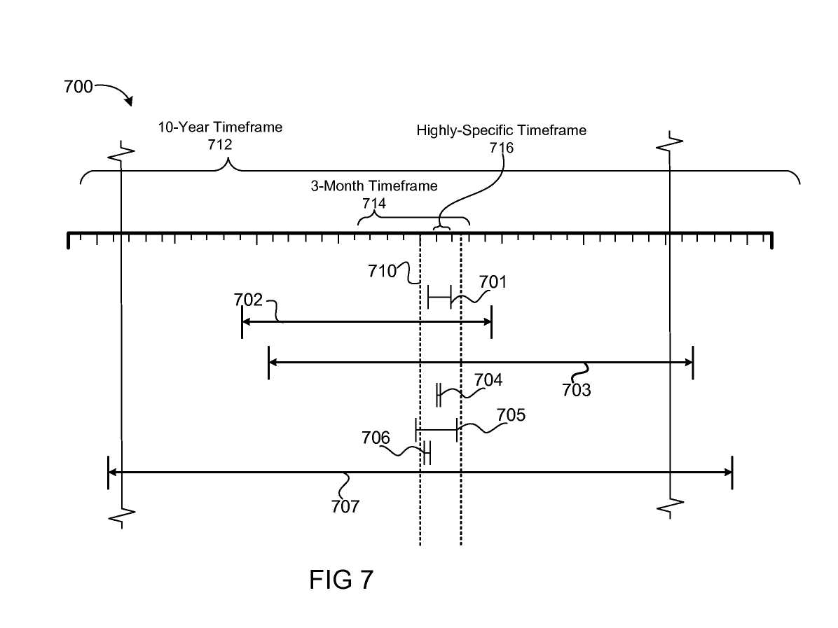

For example, consider the stories 701-707 illustrated on the chronology 700 of FIG. 7. Each of the stories 701-707 is associated with a respective timeframe: story 701 may describe coffee with a friend and may have a short timeframe of less than an hour; story 702 may relate to the birth of a child and may span a few months (late pregnancy until the child is taken home from the hospital); story 703 may describe the purchase of a new car 703 and may span the 3 years that the contributor owned the car; story 704 may describe a routine lunch with client 704 that covers a few hours, story 705 may describe a week sick in bed, story 706 may describe the contributor's experience attending a play with his wife and may span appropriately 4 hours, and story 707 may describe life at 1021 Biglong Street where the contributor lived for 6 years.

As illustrated in FIG. 7, the timeframe of the stories 701-707 may significantly differ from one another, however, each story timeframe may each within a particular week 710.

A user may browse the items 701-707 based upon a particular prevailing timeframe of interest. In some examples, the user may browse the stories 701-707 using an “intersection space” interface, such as the interfaces 300 and/or 303 described above in conjunction with FIGS. 3A and/or 3B.

The user may specify a broad prevailing timeframe, such as the 10-year span 712, which includes the week 710 that intersects all of the stories 701-707. Important stories may be identified within the prevailing timeframe 712 by comparing the story timeframes 701-707 to the prevailing timeframe 712. Given that the selected prevailing timeframe 712 is fairly broad (10 years), it may be determined that the stories that have a similarly broad timeframe will be more important than shorter-duration stories (the broader timeframe stories are more appropriate to the level of detail specified by the user in the prevailing timeframe 712). Accordingly, in the context of a 10-year timeframe 712, stories 702, 703, and/or 707 may be considered more important than stories 701, 704, 705, and/or 706, which have much narrower timeframes (and may be less appropriate to the level of detail specified by the user).

When a user specifies a different timeframe, a different set of stories may be identified as “important.” For example, when a user specifies a narrower timeframe, such as the timeframe 714 that spans approximately three months, “medium-termed” stories, such as the story about the birth of the son 702 and/or a week sick in bed 705 may be identified as more important than the longer-termed stories 703 and/or 707. Although the stories 703 and 707 intersect with the timeframe 714, they may be considered to be less important in the context of the narrower prevailing timeframe 714 specified by the user (less appropriate to the more specific level of detail indicated by timeframe 714). Similarly, the stories with the shortest timeframes (the coffee with a friend 701, lunch with a client 704, and/or attending a play 706) may be less important since their timeframes are still significantly smaller than the timeframe of interest 714 and/or the timeframe of stories 702 and 705. Conversely, when a highly-specific timeframe 716 is specified (a timeframe of a few days), the shorter termed stories, such as coffee with a friend 701, lunch with a client 704, and/or attending a play 706 may be considered to be more important than the other stories 702, 703, 704, 705, and/or 707; since the stories 701, 704, and/or 706 are more appropriate to the highly-detailed timeframe 716 specified by the user.

As described above, timeframe scale comparisons may be used to quantify the importance of items (such as stories) within a particular prevailing timeframe or chronology. However, the disclosure is not limited to timeframe comparisons, and could be extended to include any comparison metric(s) known in the art. For example, criteria, such as item timeframe scale (discussed above), timeframe correlation, item location, item repetition frequency, item content, item type (e.g., news story, biographical story, review, etc.), item quality metrics, access metrics, borrow metrics, user-provided importance indicator, and so on, may be used to determine relative item importance.

Item timeframe scale may be determined by comparing a scale of the item timeframe to a scale of the prevailing timeframe as discussed above. Item timeframe correlation may quantify the extent to which the item timeframe and the prevailing timeframe overlap. Examples of timeframe correlation metrics are disclosed above in conjunction with method 500 of FIG. 5A.

Item location metrics may quantify the correlation between an item location and a prevailing location (if specified). Like the timeframe comparisons discussed above in conjunction with method 600 of FIG. 6A, a location metric may quantify the proximity and/or overlap between an item location and a location of interest. A location metric may also compare the scale of the item location (how specifically the item location is defined) to the scale of the location of interest. The scale comparison may be performed similarly to the timeframe scale comparison(s) discussed above.

An item repetition metric may quantify how often an item is repeated (e.g. coffee with a friend). In some embodiments, item repetition may be identified automatically using item metadata (e.g., such as identifying a repeating item timeframe, location, descriptive tags, or the like). Alternatively, or in addition, a contributor may explicitly mark an item as repeating (e.g., mark the item as part of a storyline as discussed below). In some embodiments, a repeating item may be considered to be less important than less frequent items.

An item content metric may quantify importance based on the quantity and/or type of content in an item (story). For example, a story comprising only a few short lines may be considered to be as less important than a story that includes a large amount of text and/or other multimedia content (e.g., photos, video, audio, etc.).

Item type criteria may quantify item importance based on item type (e.g., story type). For example a “status” story type (a story simply relates what the contributor was doing at a particular time, e.g., “going to the store”) may not be considered as important as a “biographical” or “news” story type.

Item quality metrics may identify items that have been highly rated by other users; higher rated items may be considered more important that lower rated items. An access metric, which may quantify how many times a particular item has been viewed, may be used to identify important stories. Similarly, the number of times a story has been “borrowed” by other users may be indicative of story importance.

In some embodiments, the item contributor may provide his/her own importance indicator. The indicator may be expressed on a continuum (from 1 to 100), or using a set or pre-defined identifiers (e.g., “routine,” “frequent,” “minor,” “significant,” life-changing,” “critical,” and so on). An input configured to receive an item importance indicator may be included on a contribution interface. In some embodiments, user-provided identifiers may be displayed in a timeline indicator as “marker events.” When determining relative story importance, stories indicated as a “marker event,” may be given a high importance rating.

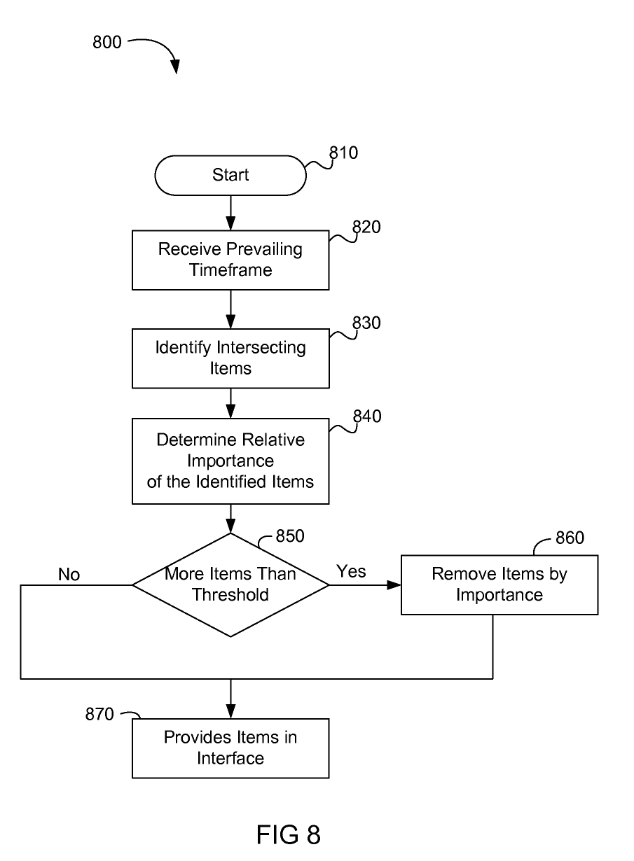

FIG. 8 is a flow diagram of one embodiment of a method 800 for identifying important items within a chronology (e.g., determining relative chronological importance). At step 810, the method 800 may start and be initialized as described above.

At step 820, a prevailing timeframe may be received. The prevailing timeframe may be part of an intersection criteria and, as such, may define an intersection space comprising a plurality of items (stories). The prevailing timeframe may be received via an interface as part of a query or browse operation. For example, the prevailing timeframe may have been provided via the timeframe control 310 described above in conjunction with FIGS. 3A and 3B.

Step 820 may further comprise receiving and/or determining an item threshold. The item threshold may determine how many items are to be returned (e.g., return no more than ten results). Alternatively, or in addition, the threshold may comprise an “importance” threshold. Items that intersect with the prevailing timeframe, but do not meet the importance threshold, may not be returned and/or presented by the method 800.

At step 830, a plurality of items that intersect the prevailing timeframe may be identified. An intersecting item may be an item having a timeframe that “overlaps” the prevailing timeframe received at step 820. In some embodiments, the intersecting items may be identified as described above in conjunction with FIGS. 1 and 2.

At step 840, a relative importance of the identified items may be determined. The relative importance of an item may be determined by comparing the scale (breadth) of the item timeline to the scale of the prevailing timeline as discussed above.

In some embodiments, determining relative importance may comprise calculating and/or combining a plurality of importance metrics for each item including, but not limited to: timeframe scale, timeframe correlation, item location, item repetition frequency, item content, item type, item quality, item access, item borrows, user provided indicator(s), and so on. As discussed above, two or more of the metrics discussed above may be combined into an “importance” metric of an item. In some embodiments, the combination may comprise applying different respective weights to each of the metrics.

At step 850, the method 800 may determine whether the number of items identified at step 830 exceeds an item threshold and/or whether the importance metric of any of the identified items fails to satisfy an importance threshold. If so, the flow may continue to step 860; otherwise, the flow may continue to step 870.

At step 860, items may be removed from the result set until the result set satisfies the item threshold. The items may be removed in “reverse” importance order, such that the items having the lowest relative importance are removed first. In addition, any items that fail to satisfy the importance metric may be removed.

At step 870, the remaining items may be provided to a user in an interface. The items may be presented by their relative importance; more important items may be displayed more prominently than less important items (e.g., at the head of an item list, in a larger/bolder font, or the like).

In addition to prominently displaying important items in a set of results, important items may be prominently displayed on a timeframe control, such as the timeframe controls 310 of FIGS. 3A and 3B. In addition, a timeframe control may be configured to display a “dynamic timeframe.” A dynamic timeframe may display different time granularities depending upon the number of intersecting items therein. For example, if a particular 3-year-time span includes only a few items, the time span may be “constricted” in that area to conserve display space. Conversely, if a particular time span includes many relevant items, that time span may be dilated in the display area in order to better depict the items. In some embodiments, the areas of time constriction and/or time dilatation may be presented in different ways to indicate to the user that a change to the time scale has been made (e.g., the background of the region(s) may be modified).

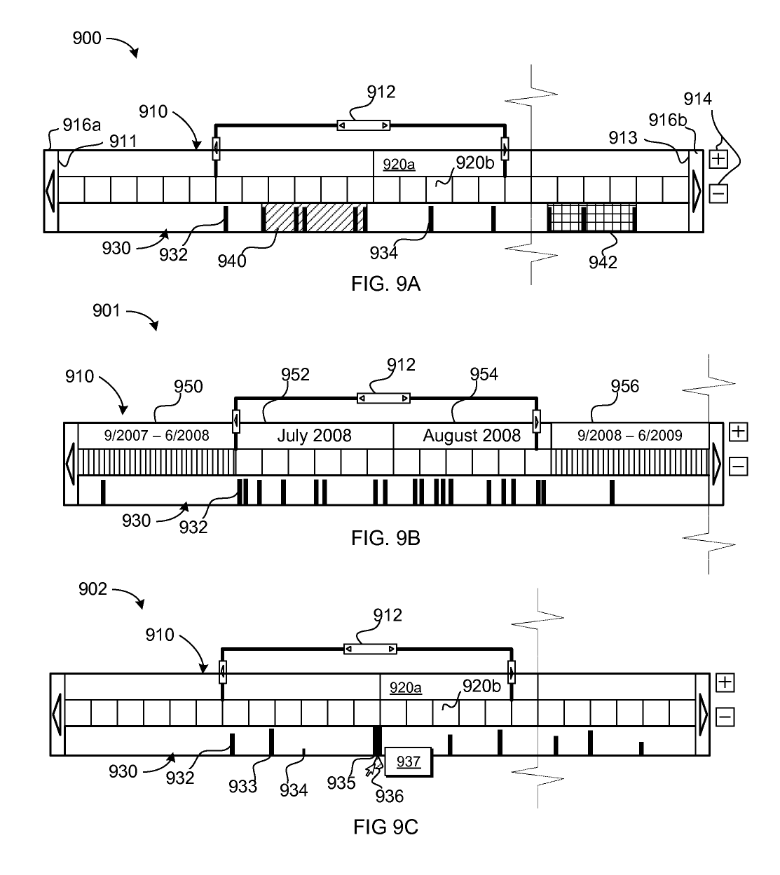

FIG. 9A depicts one example of a timeframe control 900. The control 900 may be displayed in an interface, such as the interfaces 300 and/or 303 discussed above. The control 900 may comprise a timeframe display (timeline) 910, which may span a particular time segment. The time span of the chronology display 900 may be determined using zoom controls 914. Zooming in may cause the display 910 to display a more finely-grained timeframe. When fully “zoomed-in,” the timeframe display 910 may comprise the seconds of a single minute (e.g., the chronology display 900 may have a start time 911 of Jul. 4, 2008, at 11:23:35 AM and an end time 913 of Jul. 4, 2008, at 11:24:35 AM). The intervening chronological scale may be regularly segmented by seconds, or portions of seconds. When “zoomed-out,” the timeframe display 910 may comprise a time span covering months, years, decades, or beyond.

The timeframe control 900 may include a timeframe selector 912, which, as discussed above, may be used to select a timeframe of interest (a prevailing timeframe). As the timeframe of interest changes (e.g., as the timeframe control 900 and/or timeframe selector 912 are manipulated to select different prevailing timeframes), the stories included in the resulting intersection space may change. Referring to FIGS. 3A and/or 3B, these changes may cause a different set of stories to be included in the region 330 and/or different metadata to be displayed in the elements 340, 342, 344, 346, 348, 350, and so on, as described above.

The timeframe display 910 may be labeled with a time scale. As discussed above, when “zoomed in” the labels 920a and 920b on the timeframe display 910 may be expressed as minutes within a particular hour (e.g., label 920a may read 11 AM, and label 920b may read “:28” indicating the 28th minute of 11 AM). At other levels of granularity, the labels 920a and 920b may reflect a different time scale. For example, the timeframe display 910 may span the hours of a day, and the labels 920a and 920b may read “Jul. 12, 2008” and “3 PM,” respectively. When the timeframe display 910 spans one or more months, the labels 920a and 920b may read “July 2009” and “16,” respectively. When the timeframe display 910 spans one or more years, the labels 920a and 920b may read “2009” and “Nov,” respectively. When the timeframe display 910 spans one or more decades, the labels 920a and 920b may read “2000s” and “2009,” respectively. Although a particular set of timeframe ranges (time spans) and respective labels 920a and 920b are disclosed herein, the timeframe control is not limited in this regard, and could be adapted to display any time span using any type of labeling known in the art. Moreover, other timeframe controls, such a calendar control or the like could be used under the teachings of this disclosure. The timeframe controls may reference an absolute timeframe, a “virtual timeframe,” a relative timeframe (e.g., years since the contributor's birth, where the birth year is not defined), or the like.

A user may move the timeframe display 910 in time by directly manipulating the display 910 (e.g., clicking and/or sliding the display 910), using the zoom controls 914 to change the time span or scale of the control 910, and/or using browse controls 916a and 916b to shift the control 900 forward or backward in time. On a touch screen, gestures and touches may be used to give user input to the timeframe display. A keyboard can be used as well. For example, in one embodiment the Left and Right keys scroll time backwards and forwards, respectively, and the Up and Down keys expand and contract the duration of time displayed. Likewise, holding the Shift key may cause a selected region to expand rather than change in response to a command that otherwise would change the prevailing time.

The timeframe control 910 may include a “story indicator” region 930, which may comprise indications 932 of where particular items (e.g., stories) fall within the timeframe of the timeframe control 910. Accordingly, the story indication region 930 may be “tied to” the timeframe control 910, such that the timescale and/or range displayed in the timeframe control 910 corresponds to the chronology of the story indications 932. The timeframe range on the display 910 at which a particular story indication 934 is shown indicates the timeframe of the item (e.g., the indicator 934 may correspond to a story having a timeframe comprising the time indicated by the labels 920a and 920b).

In some embodiments, the story indication region 930 may comprise a “heat” or “density” map. As used herein, a “heat map” may refer to a modification of regions within a timeframe control or story indication region 930 to indicate the quality of the items therein. For example, the items within the region 940 of the story indication region 930 may be highly rated (as determined by user-submitted ratings or another ratings source). The appearance of the intersection indications in the region 940 (or a background area of the region 940) may be modified to indicate that the region 940 comprises “hot” content (e.g., modified to have a brightly colored background). Other regions (e.g., region 942) that comprise poorly-rated content; the appearance of these regions may be modified to appear “cool” (e.g., modified to have a darker background).

As used herein, a “density map” may be used to indicate the relative density of intersecting items within a particular time span in the timeframe display 910. In some cases, the scale of the timeframe display 910 may be such that the display intersects with a large number of items. There may be so many intersecting items that it may be impractical to show indicators 932 for each one. Therefore, in certain regions of the story indicator, a density map may replace individual story indicators 932, or may be displayed along with a plurality of story indicators 932 (where it is not practical to display each indicator, a single indicator may be used to represent a plurality of intersecting items). Like the “heat” indicators discussed above, a density may change the appearance of certain regions of the timeframe display 910 and/or story indication region 930 according to the relative density of intersecting items therein. Regions comprising more intersections may be displayed in “hot” colors, whereas regions comprising fewer intersections may be displayed in “cooler” colors. In some cases, the timeframe range and/or story indication region 930 may be displayed concurrently (on different portions of the timeframe display 910 and/or story indication region 930). Alternatively, or in addition, the “heat” and “density” maps may be displayed in different ways, the heat indicator may modify the appearance of the story indicators 932, and the density map may modify a background of the story indication region 930 or timeline display 910.

As illustrated in the description of a density map, chronological Items may not be uniformly distributed in time. Certain regions of a timeframe may include many items, whereas other regions may include only a few (or none). For example, a contributor may primarily contribute stories about his/her summer vacations. Accordingly, the summer months of a timeline may be tightly packed with intersecting items, whereas other times are virtually empty. When viewing this contributor's items within a multi-year timeframe, it may be difficult to distinguish individual items due to this temporal clustering (the story indications 932 may be tightly clustered in certain regions of the story indication region 930 while other regions are empty). In some embodiments, the timeframe control 900 may comprise a dynamic timescale adapted to account for disparity in item time distribution.

FIG. 9B depicts one example of a timeframe control 901 having a dynamic time scale. As illustrated in FIG. 9A, the timeframe regions 950 and 956 comprise a coarser time scale than the regions 952 and 954; the region 950 and 956 each span ten months, whereas the regions 952 and 954 each span a single month. The difference in scale may be automatically determined based upon the time distribution of the story indications 932 in the timeframe 910 (as shown in FIG. 9B, many items intersect with the months of July and August, while the other ten-month-spans each intersect with only a single item). Displaying different timeframes in different regions may allow a user browsing the control a better depiction of item distribution; without the differing scale, the item indicators within the July and August regions 952 and 954 may appear as a single “blob.” In some embodiments, the distribution of items within a timeframe may be automatically evaluated to identify “sparse” timeframes and “dense” timeframes. Sparse timeframes may be candidates for compression, whereas dense timeframes be candidates for dilation. Under certain conditions, one or more sparse timeframes may be compressed in order to allow for one or more dense timeframes to be expanded.

As discussed above, some items (such as stories or the like) may be ordered by relative importance. See methods 500 and 600 above. The relative importance of an item may be determined empirically by comparing the item or item metadata (e.g., story timeframe, location, etc.) to intersection criteria, such as a prevailing timeframe as displayed by a timeframe control 900. The comparison may further comprise comparing item properties, such as quality, access count and the like. Alternatively, or in addition, item importance may be specified by the item contributor. For example, the contributor may mark an item as “critical,” “life changing.” These events may be classified as “marker events.”

Marker events may be used indicate life altering, watershed events that may have a permanent effect on the contributor's life. Examples of marker events may include, but are not limited to: marriage, bar mitzvah, a first trip out of the country, childbirth, graduation, and the like. A marker event may relate to something that, having happened, remains true for the remainder of the contributor's lifetime. Since marker events may be defined by the contributor, they may relate to virtually any experience. For example, tasting gelato for the first time for many people may not be particularly significant, but for some people (e.g., a chef) may represent a life-changing moment (e.g., the moment the contributor decided to become a chef). Marker events may be embodied as a story. A story may be identified as a marker event in a contribution interface, such as the interface 100 of FIG. 1A (e.g., using importance input 134 and/or selecting a “marker event” story type in input 124). In some embodiments, the relative importance of items displayed in the timeline control may be used to select a dynamic time scale as described above. For example, important items may be weighted more heavily when determine whether to compress or dilate a particular time region.

Marker events may be prominently displayed within a chronology, such as the timeframe controls 900 and/or 901 described above. FIG. 9C depicts one example of a timeframe control 902 configured to display items of varying relative importance. The appearance of the story indicators 932 in the story indicator region 930 may be modified to reflect the relative importance of the items represented thereby. In some embodiments, a height or size of the indicators 932 may indicate their importance. The indicator 933 may represent a relatively important item and, as such, may be more prominently displayed (e.g., may be taller than other, less important indicators 932). Alternatively, or in addition, the indicator 933 may be displayed in a different color or width. The indicators 932 of less important items may be displayed less prominently. For example, the indicator 934 may correspond to a relatively unimportant item and, as such, may be shorter (or of a less prominent color) than other indicators 932. As discussed above, item importance may be determined based upon a prevailing timeframe. Accordingly, as the timeframe control 900 is manipulated (e.g., to change the time scale, move within the chronology, or the like) the relative importance of the items may change, causing a corresponding change to the indicators 932.

Indicators 932 of the most important items (e.g., marker events) may be displayed prominently. The indicator 935 may represent a marker event. In some embodiments, the indicator 935 may be selectable and/or may comprise a selectable area 936, which, when selected or hovered over by a cursor, may cause an additional display element 937 to appear. The display element 937 may display a link badge of the marker event story, may provide a short description of the marker event, or the like.

The timeframe controls of FIGS. 9A-9C and/or the intersection interfaces of FIGS. 3A-3C may be presented on various different types of devices and/or using various different types of interface devices. In some embodiments, the interfaces described above may be dynamically adapted to the type of device and/or display element upon which they are presented. For example, when the intersection interface 300 of FIG. 3A is displayed on a mobile phone (or other device having limited screen area) certain interface options may be removed. Alternatively, or in addition, the network accessible service may provide interfaces adapted for particular types of devices. These interfaces may be adapted to take advantage of unique characteristics of a particular set of target devices. For instance, the network accessible service may provide interfaces configured to receive gesture input, such as a touch screen device (e.g., Apple iPhone®, iPad®, Motorola Xoom®, or the like).

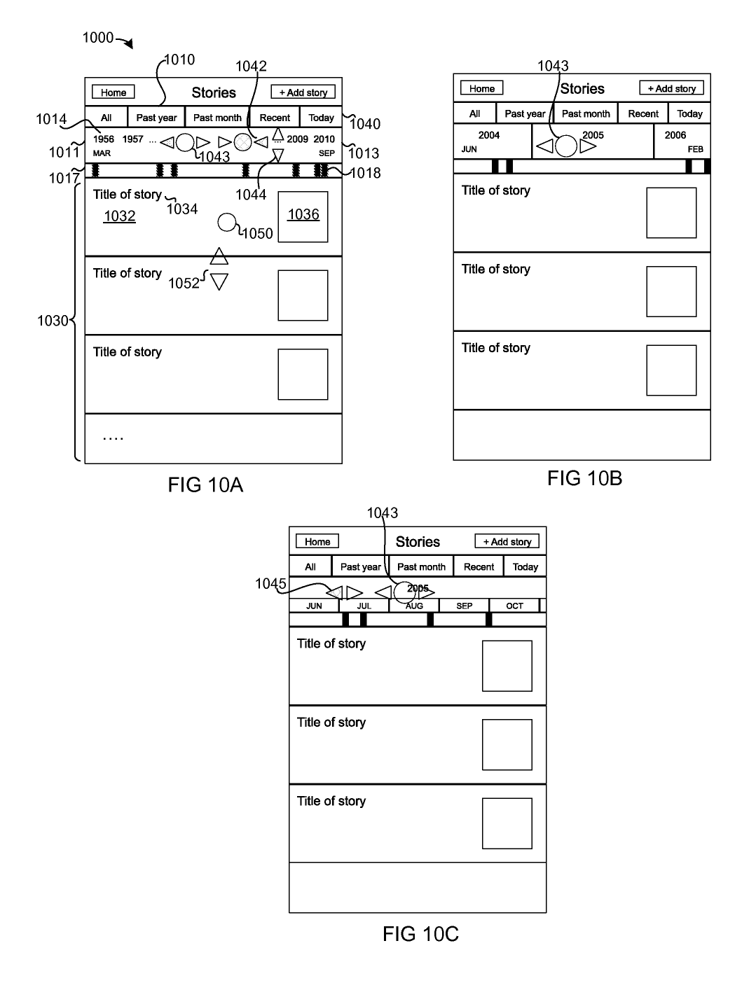

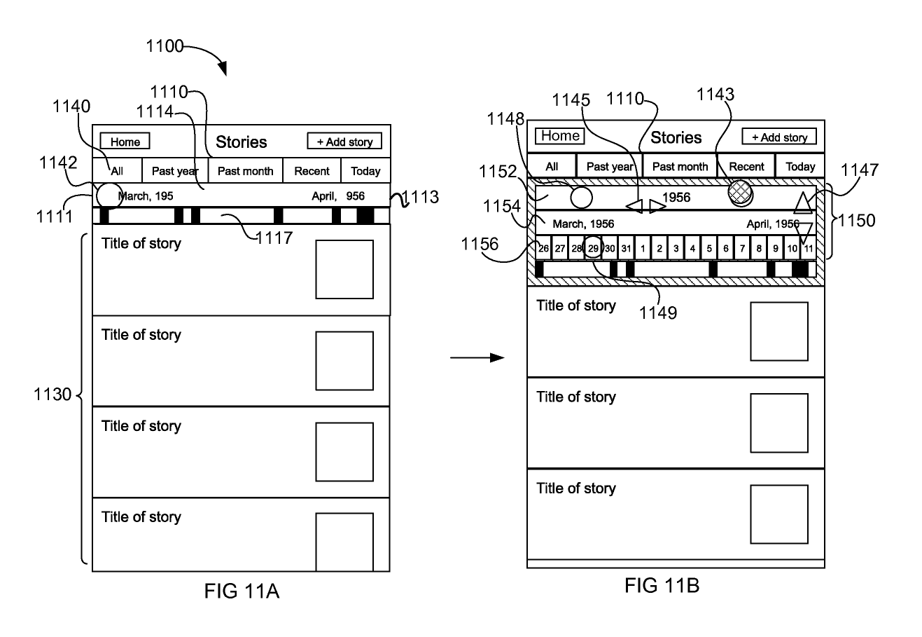

FIG. 10A depicts one example of an intersection space interface configured to respond to gesture input (e.g., touch input). The interface 1000 may be displayed on or in connection with a touch input, such as a touch screen device, a computing device having a touch pad or other gesture input device (e.g., camera, motion capture, Microsoft Kinect®, etc), or the like. The example depicted in FIGS. 10A-C may be adapted for devices having limited display area (e.g., a smart phone, PDA, or the like). However, the touch interfaces of FIGS. 10A-C (as well as the interfaces of FIGS. 11-17) could be adapted for larger display areas and, as such, should not be read as limited in this regard.

The interface 1000 includes a timeframe control 1010 that displays a prevailing timeframe 1014 defined by a start time 1011 and an end 1013 time. As shown in FIG. 10A, the prevailing timeframe 1014 comprises the entire timeframe control. In alternative embodiments, the timeframe control 1010 may include a separate control (not shown) to specify a prevailing timeframe within the control 1010 (e.g., such as the control 312 of FIGS. 3A and 3B and/or 912 of FIGS. 9A-C).

The interface 1000 includes an intersection indicator region 1017 displaying indicators of stories that intersect the prevailing timeframe 1014. In some embodiments, the intersection indicator region 1017 may be configured to display a relative density of story intersections in one or more portions of the prevailing timeframe 1014 (e.g., include “hot” and/or “cold” indicator regions as described above in conjunction with FIG. 9A). The indicators 1018 may reflect the relative importance of the stories and/or may depict milestone events as described above in conjunction with FIG. 9C.

The interface 1000 includes an intersecting story region 1030 to display an intersection space defined, at least in part, by the prevailing timeframe 1014 of the timeframe control 1010. The intersecting story region 1030 may be configured to display at least a portion of a set of one or more story indicators 1032, each story indicator 1032 corresponding to a story that intersects with the prevailing timeframe 1014 (and/or satisfies one or more other intersection criteria). Accordingly, the set of stories of the intersecting story region 1030 may comprise stories having timeframe metadata that intersects with the prevailing timeframe 1014 of the timeframe control 1010 (and/or one or more other intersection criteria). In some embodiments, the set of stories may be selected based upon the prevailing timeframe 1014 and location intersection criteria, as described above. The location intersection criteria may be specified in another interface (e.g., interface 300, 303, and/or 304 described above), another interface component (not shown), and/or may be determined automatically (e.g., based upon a current location). The story indicators 1032 may be displayed as a list (e.g., each with a title 1034 and a representative photo 1036), or in another format, such as the link badge format described above. The intersection space is defined, in part, by the prevailing timeframe 1014. Other intersection criteria, such as location, contributor, interested persons, or the like, may be defined by other interface elements (not shown). Alternatively, or in addition, the interface 1000 may be operating with pre-defined intersection criteria; for example, the interface 1000 may be configured to show the stories of a particular contributor, stories in a particular storyline, or the like. Similarly, the interface 1000 may be configured to include other types of intersection criteria, such as location, metadata tags, ratings, and the like.

The interface 1000 is configured to respond to gesture input. As used herein, a “gesture” or a “gesture input” refers to any touch- and/or gesture-based input, which includes, but is not limited to: a tap, double tap, hold, flick, pan, scroll, pinch, spread, expand, multi-touch, press and tap, press and drag, rotate, press and rotate, or the like. Gestures may be input via a touch screen, a touch pad, or other gesture input mechanism. Gesture inputs may further include non-touch inputs, such as image capture inputs, motion capture inputs, movement inputs, orientation inputs, or the like. Gesture inputs may be implemented using one or more of input mechanisms, and certain user interface elements may respond to various types of gesture inputs. For example, a “pan gesture” or “pan input,” may include, but is not limited to: a scroll gesture, a pan gesture, a flick gesture, a drag gesture, a suitable movement gesture, a suitable orientation gesture, or the like. Similarly, a “select gesture,” may include, but is not limited to: a tap gesture, a hold gesture, a double tap gesture, a suitable movement gesture, a suitable orientation gesture, or the like. Accordingly, although the disclosure describes several specific types of gesture inputs, it is not limited in this regard.

The timeframe control 1010 may be configured to display timeframes of varying granularity (e.g., different “zoom” levels). A granularity selector 1040 may be used to select an “all” timeframe (e.g., a timeframe covering all interesting stories), a timeframe covering the last year or month, recent stories, stories submitted “today,” and so on. A user may select a timeframe in the selector 1040 using a select gesture (not shown).

The timeframe control 1010 may be manipulated using gesture input. For example, the control 1010 is configured to “zoom out” in response to a pinch gesture 1042 (decreasing the granularity of the timeframe control 1010), and a spread gesture 1043 “zooms in” the timeframe control 1010 (increasing the granularity of the timeframe control 1010). The timeframe control 1010 may be further configured to receive pan gestures 1044 to zoom in and/or out in the control 1010. The pan gestures 1044 may operate similarly to the inputs 314 and 914 of FIGS. 3A, 3B, and 9A-C; pan gestures 1044 in the upwards direction may zoom in, and downward gestures 1044 may zoom out.

The story indicators 1032 in the intersecting story region 1030 may be displayed in a particular order. In some embodiments, the indicators 1032 may be ordered by relative story importance, as described above. Alternatively, the intersecting story region 1030 may be configured to order the story indicators 1032 based upon a timeframe metric, such as chronological importance (as described above in conjunction with FIG. 8), a relative start time metric and/or a timeframe correspondence metric, as described above.

A user may browse the set of stories in the intersecting story region 1030 using gesture input. A select gesture 1050 may select a story for viewing (e.g., cause a story viewing interface to be displayed, such as interface 303 of FIG. 3C). Pan gestures 1052 may scroll through the list of story indicators 1032 displayed in the region 1030. In some embodiments, pinch and/or spread gestures (not shown) are used to zoom in and/or zoom out the region 1030. For example, a pinch gesture may “zoom out” the region 1030, causing more story indicators 1032 to be displayed therein; the story indicators 1032 displayed in the “zoomed out” region 1030 may be displayed using smaller indicators 1032, such as a title only, a photo only, etc. A spread gesture (not shown) may zoom in the intersecting story region 1030, causing fewer story indicators 1032 to be the displayed; the stories displayed in the “zoomed-in” region 1030 may be displayed using larger indicators, such as the link badge indicators of FIGS. 3A and 3B.

In FIG. 10A, the prevailing timeframe 1014 of the control 1010 spans a large timeframe (from 1956 to 2010). In response to a spread gesture 1043, the timeframe control 1010 zooms in to show a more granular prevailing time 1014 as shown in FIG. 10B. In FIG. 10B, the timeframe control 1010 comprises a smaller prevailing timeframe 1014 that spans a few years (June 2004 to February 2006) as opposed to decades as in FIG. 10A. Further spread gestures 1043 cause the interface 1000 to continue increasing the zoom level of the control 1010. In FIG. 100, the prevailing timeframe 1014 of the control 1010 spans only a few months. Additional spread gestures 1043 could continue zooming the control 1010 to define even more granular prevailing timeframes 1014 (e.g., weeks, days, hours, minutes, seconds, and so on). Conversely, pinch gestures 1042 within the timeframe control 1010 cause the prevailing timeframe 1014 to zoom back out.

Pan gestures 1045 along the time axis of the timeframe control 1010 move the prevailing timeframe 1014 forward and backwards in time while maintaining the same zoom level (e.g., without changing the granularity or timescale of the control 1010). For example, a pan gesture 1045 towards the start time 1011 causes the timeframe control 1010 to move forwards in time, and a pan gesture 1045 towards the end time 1013 causes the timeframe control 1010 to move backwards in time. As shown in FIGS. 10A-C, changing the zoom level and/or prevailing timeframe 1014 of the control 1010 changes the intersection space, which may cause a different set of stories to be presented in the intersecting story region 1030 and/or shown in the intersection indicator region 1017.

The set of intersecting stories may change in response to user inputs to the timeframe control 1010 (e.g., changes to the prevailing timeframe 1014). Accordingly, the intersection space display region 1032 may be configured to modify and/or update the set story indicators 1032 in response to changes to the prevailing timeline 1014 of the timeline control 1010; such changes may include, but are not limited to: changes to the granularity of the prevailing timeframe 1014, changes to the start time of the prevailing timeframe 1014, and/or changes to the end time of the prevailing timeframe 1014. Modifications and/or updates to the set of story indicators 1032 may include, but are not limited to: adding one or more stories to the set, removing one or more stories from the set, reordering one or more stories within the set, and so on.

In some embodiments, the interface 1000 may be configured to operate using other types of inputs, such as voice commands. For example, the interface 1000 may receive a voice command specifying a particular prevailing timeframe (e.g., Sep. 14, 2004 to Sep. 28, 2004). The timeframe control 1010 may set the prevailing timeframe 1014 and zoom level, accordingly. Other, more general commands may include “show me stories from 1990,” show “January” (within the currently selected year), and so on. As would be appreciated by one of skill in the art, voice commands could be used to control any of the inputs of the interfaces and/or controls described herein. The voice commands may be used in place of, or in addition to, the gesture-based inputs described herein.

FIG. 11A shows another example of an intersection interface 1100 configured to respond to gesture input. The interface 1100 includes a timeframe control 1110 comprising a prevailing timeframe 1114 (with start time 1111 and end time 1113), an intersection indicator region 1117, an intersecting story region 1130, and a granularity selector 1140. FIG. 11A depicts a “view” state of the timeframe control 1110. In this state, the prevailing time of the control 1110 is viewable, but may not be modifiable. The timeframe control 1110 may transition to an “editable” mode depicted in FIG. 11B in response to a select gesture 1142 (or double tap, not shown) on the control 1110.

In the FIG. 11B example, the timeframe control 1110 includes a plurality of timeframe fields 1150, including a year field 1152, a month field 1154, and a day field 1156. Although a particular set of fields is depicted in the FIG. 11B example, the control 1110 could include any set of fields 1150 corresponding to any timeframe control 1110 zoom level and/or granularity. For example, when zoomed in to a specific day, the fields may include a week field (not shown), a day field (1154), and an hours field (not shown). When zoomed out, the fields may include a centuries field (not shown), decades field (not shown), and the years field 1152.

Pan gestures 1145 along the time axis of the control 1110 may cause the timeframe control 1100 to move backwards and/or forwards in time (while maintaining the same zoom level). A select gesture 1148 in a particular field 1150 may “commit” the timeframe control to the corresponding field 1150. For example, a select gesture 1148 in the years field 1152 may cause subsequent pan gestures 1145 to scroll the timeframe year-by-year. A select gesture in another field (e.g., the months field 1154) may cause subsequent pan gestures 1145 to scroll the timeframe control 1110 month-by-month, and so on.

Pan gestures 1147 perpendicular to the time axis of the control 1110 may cause the selected zoom level to change. For example, a downwards pan gesture 1147 may zoom out the control 1110, whereas an upwards pan gesture 1147 may zoom in the control 1110. The gestures 1147 may operate similarly to the inputs 514 of FIGS. 5A and 5B and/or the 1114 of FIGS. 11A-C. The pan gestures 1147 may cause the fields 1150 of the timeframe control 1110 to change (e.g., the fields 1150 may change to reflect the changing zoom level of the control 1110).

A select gesture 1149 on a specific date may cause the timeframe control 1110 to zoom to that date (e.g., zoom to Mar. 29, 1956). The granularity of the timeframe control 1110 may change in response to the select gesture 1149 (e.g., change to a granularity showing the week, day, and hours of Mar. 29, 1959). In some embodiments, the select gesture 1149 may “commit” the timeframe control to the selected zoom level, such that subsequent pan gestures 1145 cause the timeframe control 1110 to scroll day-by-day.

The timeframe control 1110 may revert back to the “view” mode of FIG. 11A when a repeat of the select gesture 1142 is received and/or in response to another input (e.g., a double tap gesture 1143).

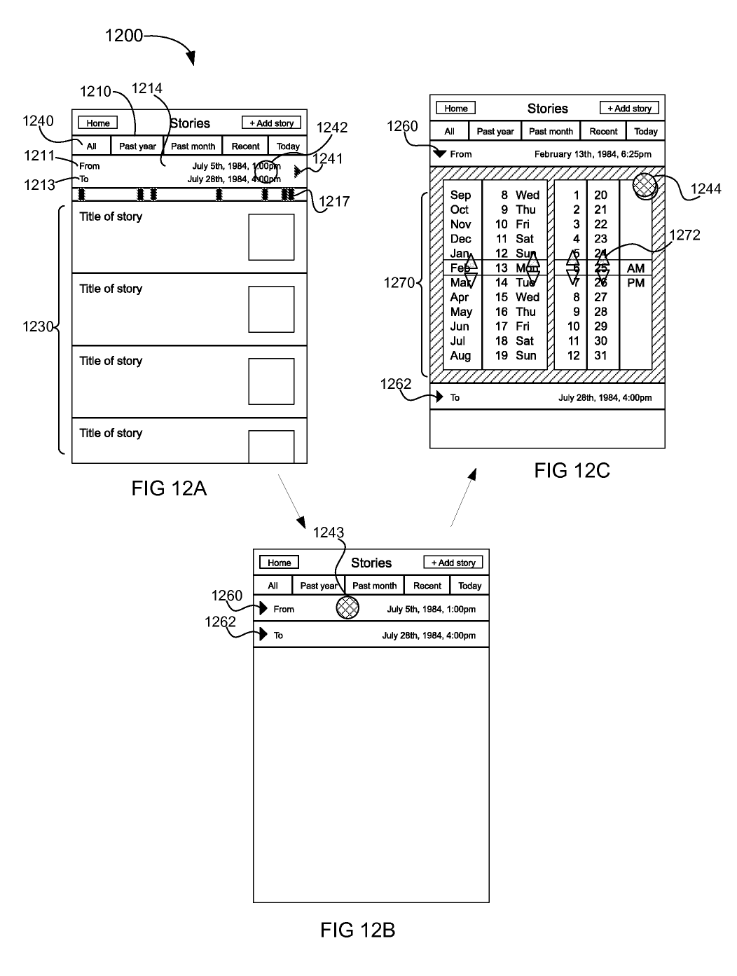

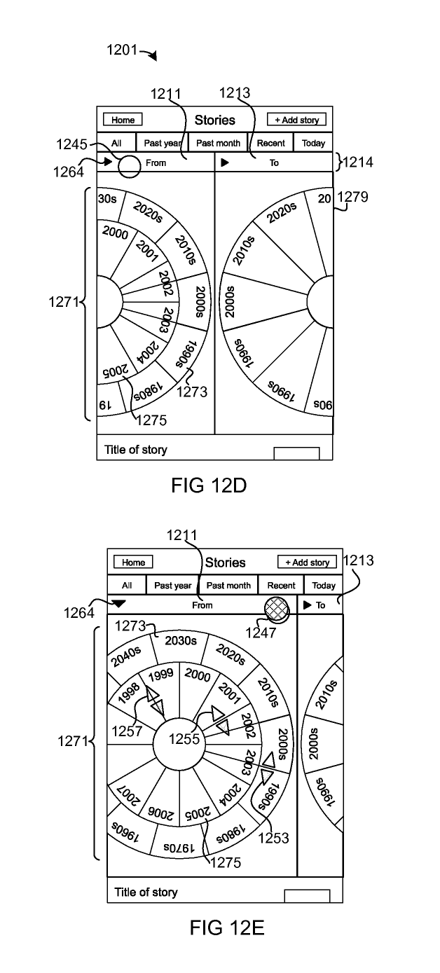

FIG. 12A depicts another example of an interface 1200 configured for gesture input. The FIG. 12A example includes a timeframe control 1210, an intersection indicator region 1217, an intersecting story region 1230, and a granularity selector 1240. The timeframe control 1210 includes a “from” time label 1211 indicating a start time of the prevailing time 1214, and a “to” time label 1213 indicating an end time of the prevailing time 1214.

The timeframe control 1210 responds to a select gesture 1242 in the control 1210 (or on the selector 1241) by transitioning into an “editable mode” depicted in FIG. 12B. The editable mode of FIG. 12B allows editing of the prevailing timeframe 1214. An editor for the “from” or “to” time is invoked by a select gesture 1243 in the respective label 1211 or 1213 and/or on a respective one of the selector inputs 1260 or 1262.

FIG. 12C depicts an example of an editor for setting the prevailing time 1214 of the control 1210 (e.g., setting the “from” and/or “to” time). FIG. 12C depicts the “from” time being set using a series of scrollable fields 1270. However, other input mechanisms could be used, such as the “wheel” interface described below in conjunction with FIGS. 12D-E. The “from” time is set using pan gestures 1272 within the fields 1270 (a pan gesture 1272 in any of the fields 1270 modifies the value of the respective field). A user may switch between editing the “to” and/or “from” times using the selector inputs 1260 and 1262. Deselecting both editing inputs 1260 and 1262 may cause the timeframe control 1210 to revert to the “view” mode of FIG. 12A. Alternatively, or in addition, the interface 1200 may revert to the “viewable” mode of FIG. 12A in response to a double tap gesture 1244, or other input.

FIGS. 12D and 12E depict another example of intersection interfaces 1201 for receiving gesture input. The examples of 12D and 12E could be used in connection with the interface 12A-B (e.g., in place and/or in addition to the scroll editing interface of FIG. 12C).

The interface 1201 uses gesture-controlled wheels 1271 and 1279 to edit the prevailing timeframe 1214. A select gesture 1245 on the “from” label and/or the selector 1264 (and/or interacting with the from wheel 1271) causes the from scroll wheel 1271 to transition into an “editable” mode, as depicted in FIG. 12E. The scroll wheel 1271 may be manipulated using pan gestures on the “hubs” of the wheels. For example, a pan gesture 1253 on the decades hub 1273 scrolls the “from” time decade-by-decade, and a pan gesture 1255 on the year hub 1275 scrolls the “from” time year-by-year. A pan gesture 1257 along the radius of the wheel 1271 may change the granularity of the wheel hubs 1273 and 1275. A pan gesture 1255 away from the center of the wheel 1271 may cause the wheel 1271 to “zoom in,” increasing the granularity of the hubs 1273 and 1275; for example, the hub 1273 may transition to a “year” scale, and the hub 1275 may transition to “months” scale. A pan gesture 1257 towards the center of the wheel 1271 may cause the wheel 1271 to “zoom out,” decreasing the granularity of the hubs 1273 and 1275. A select and/or double tap gesture 1247 in the from label 1211 and/or on the wheel 1271 may fix the from time and/or cause the interface 1201 to revert to the “view” form of FIG. 12A or the editing form of FIG. 12D. The wheel 1279 of the “to” time 1213 may operate similarly to the from wheel 1271 described above.

The intersection interfaces described herein may be used with a device capable of receiving movement and/or orientation input (e.g., a device comprising an accelerometer, gyroscope, camera, motion capture device, or the like). As used herein, movement input refers to any movement and/or orientation-based input known in the art including, but not limited to: gyroscopic input, accelerometer input, pointer input, or the like.

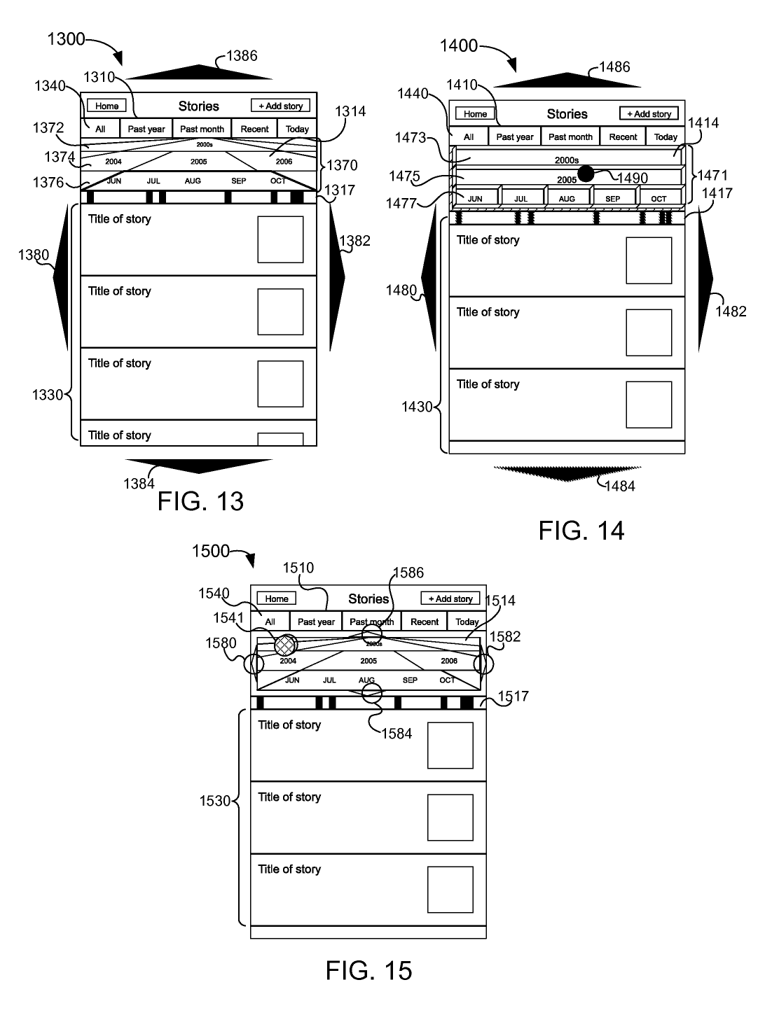

FIG. 13 depicts one example of an intersection interface 1300 configured to receive movement input. The interface 1300 includes a timeframe control 1310 displaying a prevailing timeframe 1314, an intersection indicator region 1317, an intersecting story region 1330, and a timeframe granularity selector 1340.

The timeframe control 1310 includes a plurality of timeframe granularities or fields 1370, including a decade field 1372, an annual field 1374, and a month field 1376. The selected field determines the “zoom level” of the timeframe control 1310. As shown in FIG. 13, the currently selected field is the “month” field 1376, and as such, the time range 1314 of the control spans June 2005 to October 2005. Although FIG. 13 shows a particular set of fields 1370, the disclosure is not limited in this regard; the interface 1300 be configured to include any number of different timeframe granularity fields depending upon a current zoom level of the timeframe control 1310.

The prevailing timeframe 1314 may be scrolled backwards and/or forwards in time by tilting the interface to the right 1380 and/or left 1382, respectively. The rate of change of the timeframe control 1310 is determined by the selected timeframe field 1370. When the interface 1300 of Example 13 is tilted to the right 1380 or left 1382, the timeframe control 1310 moves through the timeline month-by-month. The interface 1300 may also scroll the timeframe control 1310 in response to gesture input (not shown), such as pan gestures, or the like.

The selected field of the timeframe control 1310 may be modified by tilting the interface 1300 towards 1384 or away 1386 from the user. Tilting the interface 1300 towards the user 1384 may zoom out the timeframe control 1310 (e.g., transition from a month field 1376 to the year field 1374, and so on), whereas tilting away 1386 may zoom in the control 1310 (e.g., transition from the month field 1376 to a week field, not shown).

FIG. 14 depicts another example of an intersection interface 1400 configured to receive movement input. The interface 1400 comprises a timeframe control 1410, prevailing timeframe 1414, an intersection indicator region 1417, an intersecting story region 1430, and a granularity selector 1440.

The timeframe control 1410 includes a plurality of fields 1471, each corresponding to a respective timeframe granularity. The FIG. 14 example depicts a decade field 1473, a year field 1475, and a month field 1477. However, other fields of other granularities may be included according to the current zoom level of the timeframe control 1410 (e.g., a century field, a week field, a day field, hour field, and so on).

The prevailing timeframe 1414 of the control 1410 may be modified using a movement-controlled interface element 1490. The interface element 1490 may move within the fields 1471 in response to movement inputs 1480, 1482, 1484, and/or 1486. The movement of the element 1490 may be similar to a marble on a table: tilting the interface 1400 in the direction 1480 may cause the element 1490 to move to the right; tiling the interface 1400 in the direction 1482 may cause the element 1490 to move to the left; tilting the interface in the direction 1484 may cause the element 1490 to move down (e.g., zoom in, to more granular fields 1471 of the interface); and tilting the interface in the direction 1486 may cause the element 1490 to move up (e.g., zoom out, to less granular fields 1471 of the interface). Moving the interface element 1490 to the right or left edge of the control 1410 may cause the prevailing timeframe to scroll backwards and/or forwards in time. Moving the interface element 1490 to the top portion of the topmost field 1473 may zoom out the control 1410 (e.g., cause lower granularity fields 1471 to be displayed in the control 1410), whereas moving the interface element to the bottom portion of the bottommost field 1477 may cause the control 1410 to zoom in (e.g., cause higher granularity fields 1471 to be displayed in the control 1410).

The element 1490 may be selectively fixed within the interface using a select gesture 1442. Alternatively, or in addition, the element 1490 may be selectively fixed using another type of input, such as a button (not shown), a movement input (e.g., maintaining the interface 1400 flat for a pre-determined period of time, performing a movement gesture, or the like). When the element 1490 is fixed, the timeframe interface 1410 may zoom in or out according to the position of the element 1490 in the fields 1471. For example, if the element 1490 is fixed in a particular month; the timeframe control 1410 may zoom into the month (e.g., the fields 1471 may be modified to include a month field 1477, week field, not shown, and day field, not shown).

FIG. 15 depicts another example of an intersection interface 1500 configured to receive gesture input. The interface 1500 includes a timeframe control 1510 comprising a prevailing timeframe 1514, an intersection indicator region 1517, an intersecting story region 1530, and a granularity selector 1540.

A select or double tap touch gesture 1541 may cause the timeframe control 1510 to enter an editable mode. When in the editable mode (and as depicted in FIG. 15), the interface 1500 may respond to select gestures 1580, 1582, 1584, and/or 1586 which may modify the prevailing time of the control 1510. The select gestures 1580, 1582, 1584, and 1586 may operate similarly to the movement inputs of FIGS. 13 and 14; the select gestures 1580 and 1582 may scroll the prevailing time backwards and forwards in time (while retaining the current zoom level), and the select gestures 1584 and 1586 may increase or decrease the zoom level of the control 1510. The interface 1500 may transition to/from the editable via select and/or double tap gestures 1541 on the timeframe control 1510.

In some embodiments, the interface 1500 may be implemented with the movement interfaces 1300 and/or 1400 to form an interface capable of receiving gesture input that comprises touch-based gesture input as well as movement and/or orientation input.

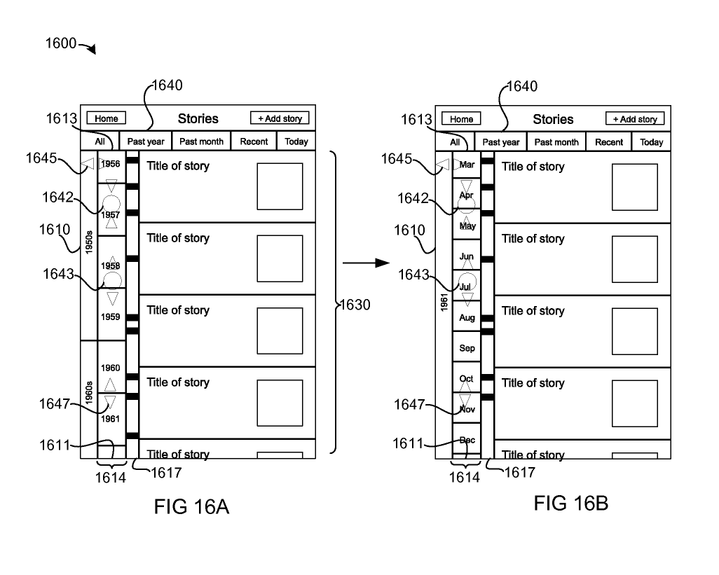

FIG. 16A shows another example of an intersection interface 1600 configured to receive gesture input. The interface 1600 includes a timeframe control 1610 comprising a prevailing time 1614 defined by a start time 1611 and end time 1613, an intersection indicator region 1617, an intersecting story region 1630, and a granularity selector 1640.

A pinch gesture 1642 may be used to zoom out the timeframe control 1610. A spread gesture 1643 may be used to zoom in the timeframe control 1610. Pan gestures 1645 may also be used to control the zoom level of the timeframe control 1610. A pan gesture 1645 to the right of the interface 1600 may zoom in the control 1610, and a pan gesture 1645 to the left of the interface 1600 may zoom out the control 1610. The prevailing timeframe 1614 may be scrolled using pan gestures 1647 along the time axis of the control 1610. A pan gesture 1647 towards the bottom of the interface 1600 may scroll the prevailing timeframe 1614 backwards in time, and a pan gesture 1647 towards the top of the interface 1600 may scroll the prevailing timeframe 1614 forward in time. FIG. 16B shows the result of zooming in the timeframe 1610 (e.g., using spread gesture 1643 and/or a pan gesture 1645), and scrolling the control 1610 forwards in time (e.g., using a pan gesture 1647). As illustrated in FIG. 16B, the zoom level of the timeframe control 1610 is increased (e.g., displaying a single year as opposed to decades).

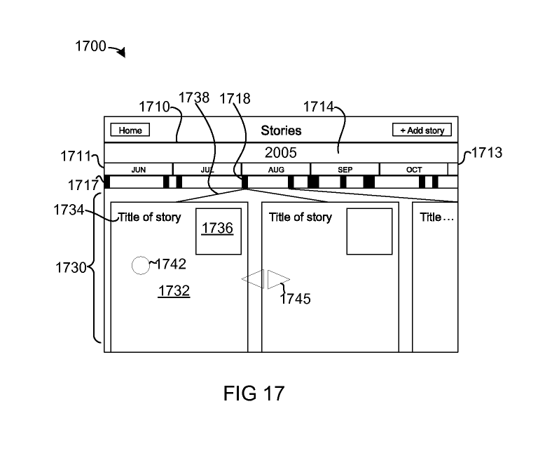

FIG. 17 depicts another intersection interface 1700 configured to receive gesture input. The interface 1700 may be adapted for display in a “landscape” format. In some embodiments, the interfaces described herein may be configured to dynamically switch between a portrait display mode (e.g., as in FIGS. 11A-16B) and the landscape display mode (or a variant thereof) depicted in FIG. 17. The switching may be based upon movement and/or orientation input. For example, the interfaces described herein may receive movement inputs indicating that the interface (e.g., interface 1700) is being held in a landscape orientation. In response, the interface 1700 may switch into a landscape display mode. When movement inputs indicate that the interface 1700 is being held in a portrait orientation, the interface 1700 may switch into a portrait display mode. In some embodiments, the interfaces described herein may include a “lock” setting to lock the interface in a particular orientation regardless of the movement and/or orientation inputs. The lock setting may allow the user to specify a preferred orientation for the interface 1700 (and/or other interfaces described herein).

The interface 1700 includes a timeframe control 1710, comprising a prevailing time 1714 defined by a start time 1711 and end time 1713, an intersection indicator region 1717, and an intersecting story region 1730. The timeframe control 1710 may be configured to receive gesture input (not shown) to zoom the control 1710 in and/or out, to scroll backwards and/or forwards in time, and so on as described above.

The intersecting story region 1730 may display indicators 1732 of the stories that intersect the prevailing timeframe 1714 (and/or other intersection criteria, not shown). A story indicator 1732 may display varying levels of detail about a particular story. In the FIG. 17 example, the indicator 1732 displays a story title 1734 and photo 1736. However, other display formats, such as the link badge format described above, could be used in connection with the interface 1700.

A select gesture 1742 in a particular story indicator 1732 may cause a story display interface to be presented, such as the interface 304 described above in conjunction with FIG. 3C. Alternatively, or in addition, the select gesture 1742 may cause additional detail about the story to be displayed in the intersecting story region 1730 (e.g., display link badge information in an expanded indicator 1732 or the like). Pan gestures 1745 within the region 1730 may scroll through the stories in the prevailing timeframe 1714. In some embodiments, when the start 1711 or end 1713 time of the prevailing timeframe 1714 is reached (by scrolling in the region 1730), the prevailing timeframe 1714 may automatically scroll forward or backward accordingly. Selecting any of the story indicators 1718 in the intersection indicator region 1717 may cause the intersecting story region 1730 to display indicators of the corresponding stories. Reference links 1738 may be displayed to provide a visual association between a particular story 1732 and a corresponding story indicator 1718.

In some embodiments, spread and/or pinch gestures (not shown) within the intersecting story region 1730 may cause the region 1730 to zoom out/in. Zooming in may cause fewer, higher-detail story indicators 1732 to be displayed in the region 1730 (e.g., the story indicators 1732 may be displayed in link badge format). Zooming out within the region 1730 may cause more story indicators to be displayed, but may reduce the amount of detail provided in each indicator.

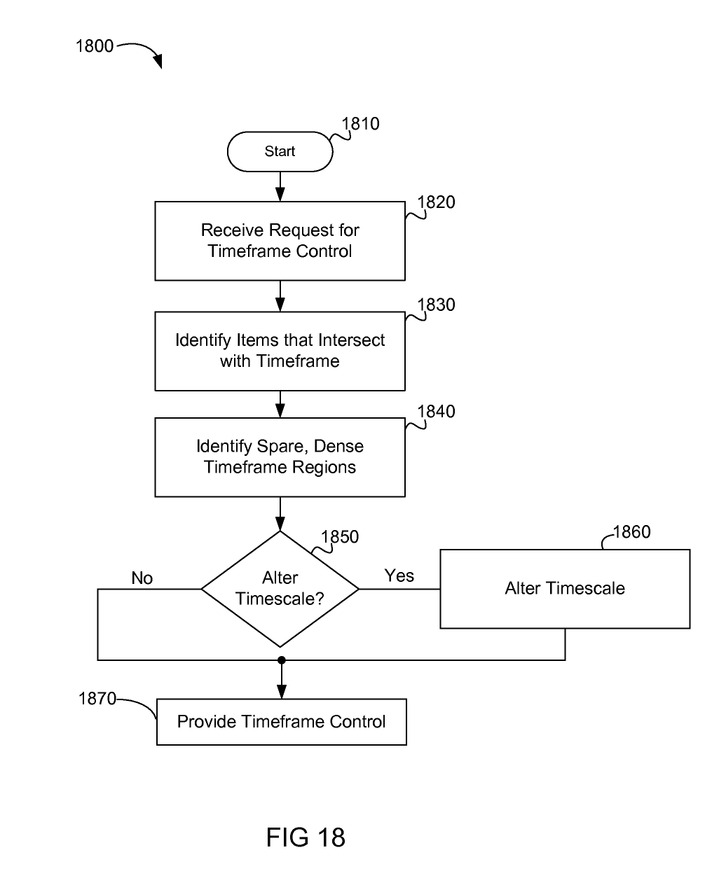

FIG. 18 is a flow diagram of one embodiment of a method 1800 for displaying a timeframe control in an interface, such as the intersection interfaces described above.

At step 1810, the method 1800 may start and be initialized as described above. At step 1820, a request for a timeframe control may be received. The request may be issued responsive to a user interaction with an intersection interface, such as the interfaces of FIGS. 3A-B, 9A-C, and/or 10A-17. In some embodiments, the request may include a timeframe of interest (the request may indicate that the timeframe control is to display a timeframe having a particular start time and a particular end time). Alternatively, or in addition, the timeframe of interest may be received responsive to user manipulation of a timeframe control (responsive to the user manipulating zoom controls, browse controls, or the like).

At step 1830, a set of items intersecting with the timeframe to be covered by the timeframe control may be identified. The items may be identified as described above (e.g., by comparing a timeframe of the item(s) to the timeframe of the timeframe control).

At step 1840, a time distribution of the identified items may be evaluated to identify “sparse” regions and/or “dense” regions. In some embodiments, step 1840 may comprise evaluating ratings of the identified items. As discussed above, item ratings may be used mark “hot” or “cold” areas on a timeline control.

At step 1850, the method 1800 may determine whether a time scale of the control should be altered. In some embodiments, the determination of step 1850 may comprise determining whether the “sparse” regions identified at step 1840 are sufficiently sparse that compression would not render them unsuitable for use. The determination may comprise calculating a “compression threshold,” which may be based upon the number of items in the sparse region(s) to a desired level of compression. The compression threshold may indicate how much a particular region may be compressed before item density becomes too great (e.g., item density may not exceed a particular compression threshold). Step 1850 may further comprise calculating a “dilation threshold” for dense regions, which may quantify how much dilation would be required to reach a desired item density. The threshold(s) may be compared to determine whether changing the time scale would result in a net benefit (e.g., improve the dense regions by dilation while not rendering the sparse regions unusable as a result of excess compression). The comparison may comprise comparing the compression threshold to the dilation threshold of various regions. If neither threshold can be satisfied, the time span may be unchanged, or the approach representing the “best” result may be selected. The best result may be the result that provides some improvement to the sparse regions (but not reaching a dilation threshold) while minimizing adverse effects on the compressed regions (while perhaps exceeding a compression threshold). In some embodiments, the relative importance of the items used to weight the thresholds and/or determine whether to modify the time scale. For example, the dilation threshold of a region comprising important items may be increased to ensure that the indicators for these important items are adequately displayed (perhaps to the detriment of other, less important indicators). Similarly, the compression threshold of a region comprising important (e.g., a marker event) may be increased to prevent the region from being compressed in favor of other, less important item indicators.

If the method 1800 determines that the timescale is to be modified, the flow may continue to step 1860; otherwise, the flow may continue to step 1870.

At step 1860, a dynamic timescale for the timeframe control may be determined. As discussed above, the dynamic timescale may compress sparse regions of the timeframe and dilate dense regions. The degree to which each region is compressed or dilated may be based on the compression/dilation thresholds described above.

At step 1870, a timeframe control may be provided for presentation to a user. Step 1870 may comprise providing a timeframe directive to a control (including a dynamic time span), providing item indicators for display on the control, and so on. Step 1870 may further comprise determining whether to display intersecting items as individual indicators, or in some other way, such as composite indicators, density regions or the like. For example, if all of the regions are considered to “dense” (exceed a dilation threshold), and there are no sparse regions to compress, the method may consolidate item indicators into composite indicators and/or depict intersecting items within “density regions” discussed above.

Step 1870 may further comprise marking regions by rating and/or by density. In some embodiments, item ratings (evaluated at step 1840) may be used to mark certain regions of the timeframe control as “hot” and/or “cold.” Marking a region may comprise directing a display component to modify an appearance of one or more display components (e.g., modify the background color of a region of the story indication region 930 of FIG. 9A). Region density may be similarly marked.

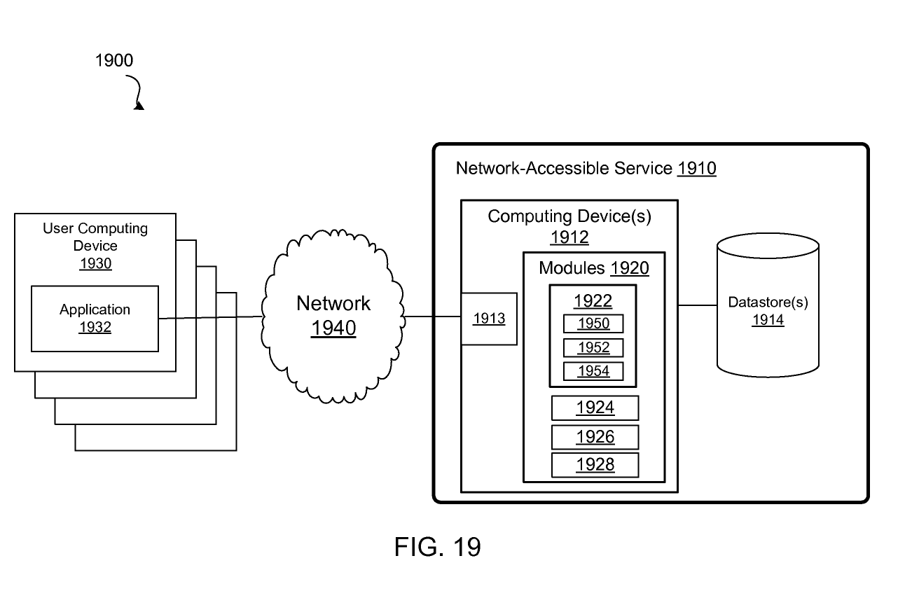

FIG. 19 is a block diagram of one embodiment of a system 1900 and apparatus 1910 for providing the features taught herein. The apparatus 1910 may provide network-accessible services to one or more users 1930 via a network 1940. The network 1940 may comprise any communication mechanisms known in the art including, but not limited to: a TCP/IP network (e.g., the Internet), a LAN, a WAN, a VPN, a PSTN, a wireless network (e.g., radio, IEEE 802.11), a combination of networks, and so on. The apparatus 1910 may comprise one or more computing devices 1912, each comprising one or more network interfaces 1913 to communicatively couple the apparatus 1910 to the network 1940.

The apparatus 1910 may be configured to communicate with the user computing devices 1930 via the network 1940 to receive information therefrom, such as user registration information, user profile information, user-submitted content, metadata, intersection criteria, and so on, as disclosed above. The user computing devices 1930 may be operated by respective users (not shown), and may each comprise an application 1932 configured to interface with the network-accessible service 1910 via the network 1930. The user computing devices 1930 may comprise personal computer, laptops, cellular phones (e.g., smart phones), handheld computing devices, tablet computers or the like. The applications 1932 may be configured to communicate with the network-accessible service 1910. In some embodiments, the application(s) 1932 may comprise general purpose web-browser applications, standalone applications, special purpose applications, application plug-ins, or the like.

The apparatus 1910 may store user-submitted content, user-provided information (e.g., profile information, circle membership, etc), and/or records of user interactions with the apparatus 1910 in one or more datastores 1914. The datastores 1914 may comprise computer-readable storage media, such as hard disks, non-volatile solid-state storage devices, and the like. The datastores 1914 may provide data storage services, such as database storage services, directory services, and the like.

The apparatus 1910 may provide various user interfaces, through which the users 1930 may: author, contribute, upload, and/or publish user-submitted content; manage content collections (e.g., storylines); present user-submitted content; search or browse user-submitted content; manage user profile or account information; maintain user privacy settings; manage access control preferences; and so on, as disclosed herein. The interfaces provided by the apparatus 1910 may be configured to be presented on various different human-machine interfaces provided by various different types of user computing devices 1930, as disclosed above.

The apparatus 1910 (via the computing devices 1912) may implement one or more modules, which may be embodied as computer-readable instructions stored on the datastores 1914. The instructions may be executable by processing resources (not shown) of the computing devices 1912. The modules 1920 may include an interface module 1922 configured to provide the interfaces described herein. In some embodiments, some of the interfaces may be provided as browser-renderable markup. Accordingly, the interface module 1920 may comprise a web server.

The apparatus 1910 may comprise a storage module 1924 configured to store, and/or index user-submitted content received via the interfaces provided by the interface module 1922. The user-submitted content may include, but is not limited to: photographs, text, video, audio, content collections (e.g., stories, storylines), metadata, user profile information, user preferences, security settings, and so on. The interface module 1922 may be configured to present content stored on the storage module 1924 as described above.

The apparatus 1910 may comprise an analysis module 1924, which may be configured to analyze user-submitted content, metadata, and/or user interactions with the apparatus 1910 to determine user stage of life, disposition, identify user affinities, identify intersections, and so on, as described above. The analysis module 1924 may make the results of the analysis available to the other modules (e.g., interface module 1920) for display.

In some embodiments, the apparatus 1910 may include an access control module 1926, which may control access to user-submitted content, user profile information, and the like, as described above. Accordingly, the access control module 1926 may store records (on the datastores 1914) of user-defined circles, aliases, and the like. User registration, user profile, user modeling, and other information may be maintained by a user module 1928. The user module 1928 may store the user information described above on the datastores 1914. The apparatus 1910 may use the computing devices 1912, datastores 1914 and/or modules 1920, 1922, 1924, 1926, and/or 1928 to implement the features described above.

In some embodiments, the interface module 1922 may be configured to provide a timeframe control, as described above. The timeframe control may be provided by a timeframe control module 1950. The timeframe control module 1950 may be configured to provide for displaying a timeframe control on a gesture-enabled computing device, such as the timeframe controls described in conjunction with FIGS. 10A-17. Accordingly, portions of the timeframe control module 1950 (as well as the other modules 1920, such as 1952 and 1954), may be configured to operate on a user computing device 1930 and/or be part of the application 1932, described above. The user interface module 1922 may further comprise an intersecting story region module 1952. The intersecting story region module 1952 may be configured to provide an intersecting story region display region, such as the region 1030 described above. The intersecting story region may be configured to display indicators of stories that intersect with the prevailing timeframe of the timeframe control of the timeframe control module 1950. The intersecting story region may be configured to respond to gesture input, operate on a user computing device 1039 and/or application 1932, as described above. The interface module 1922 may further comprise an intersection indicator module 1954 configured to provide an intersection indicator region, as described above. The intersection indicator region may be configured to display intersection indicators corresponding to story intersections on a prevailing timeframe and/or display indicators of intersection density within portions of the prevailing timeframe, as described above.

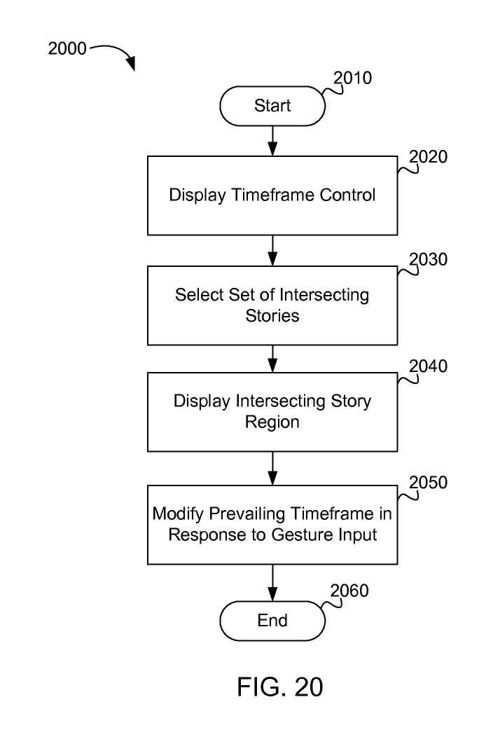

FIG. 20 is a flow diagram of one embodiment of a method for displaying an intersection space on a gesture-enabled display. Portions of one or more of the steps of the method 2000 may be implemented on the user computing device 1930 (as part of an application 1932), and other portions may be implemented on the network-accessible service 1940. At step 2010 the method starts and is initialized as described above.

Step 2020 may comprise displaying a timeframe control on the display of the computing device (e.g., a display of a user computing device 1930). The timeframe control may be configured to display a prevailing timeframe. The timeframe control may be further configured to modify the prevailing timeframe in response to gesture inputs.

In some embodiments, step 2020 may further comprise displaying an intersection indicator region. The intersection indicator region may be displayed as part of the timeframe control and/or as a separate interface component. The intersection region may comprise indicators of story intersections on the prevailing timeframe (as determined at step 2030, described below). Each intersection indicator may correspond to one or more stories that intersect with the prevailing timeframe. Step 2020 may further comprising displaying one or more indicators of relative density of one or more portions of the prevailing timeframe, as described above (e.g., hot and cold indicators, as described above in conjunction with FIG. 9A).

Step 2030 may comprise identifying stories that intersect with the prevailing timeframe of the timeframe control (e.g., stories having timeframe metadata that intersects with the prevailing timeframe). The selection of step 2030 may further comprise selecting and/or identifying stories based upon one or more other intersection criteria, as described above (e.g., location, ratings, people, tags, keywords, or the like). For example, in some embodiments, step 2030 comprises identifying stories that intersect with the prevailing timeframe and a location intersection criteria. The location intersection criteria may be specified by a user via one or more interface components, may be determined automatically (e.g., the current location of the user or computing device), or the like.

Step 2040 may comprise displaying an intersecting story region, comprising at least a portion of a set of story indicators in an intersecting story region, each story indicator corresponding to a story in the set of stories selected in step 2030. The story indicators may be displayed in an intersecting story region, which may be configured to respond to gesture input, as described above. Step 2040 may further comprise ordering the stories in the set. Ordering the stories may comprise determining an order in which the story indicators are displayed within the intersecting story region, changing the manner in which the story indicators are displayed (e.g., displaying some story indicators more prominently than others), and so on. In some embodiments, the story indicators may be ordered based upon chronological importance, a relative start time metric, a timeframe correspondence metric, or other timeframe-related metric, as described above.

Step 2050 may comprise modifying the prevailing timeframe in response to a gesture input. As described above, the gesture input may comprise a touch input, an orientation or movement input, or the like. The modification to the prevailing timeframe may include, but is not limited to: changing the granularity of the prevailing timeframe and/or timeframe control, changing a start time of the prevailing timeframe, changing an end time of the prevailing timeframe, or the like, as described above.

In some embodiments, step 2050 may further comprise modifying and/or updating the story indicators displayed within the intersecting story region in response to modifying the prevailing timeframe. The modification and/or update may include, but is not limited to: adding one or more stories to the set, removing one or more stories from the set, reordering one or more stories within the set, or the like. The method 2000 ends at 2060.

The above description provides numerous specific details for a thorough understanding of the embodiments described herein. However, those of skill in the art will recognize that one or more of the specific details may be omitted, or other methods, components, or materials may be used. In some cases, operations are not shown or described in detail.

Furthermore, the described features, operations, or characteristics may be combined in any suitable manner in one or more embodiments. It will also be readily understood that the order of the steps or actions of the methods described in connection with the embodiments disclosed may be changed as would be apparent to those skilled in the art. Thus, any order in the drawings or Detailed Description is for illustrative purposes only and is not meant to imply a required order, unless specified to require an order.

Embodiments may include various steps, which may be embodied in machine-executable instructions to be executed by a general-purpose or special-purpose computer (or other electronic device). Alternatively, the steps may be performed by hardware components that include specific logic for performing the steps, or by a combination of hardware, software, and/or firmware.

Embodiments may also be provided as a computer program product including a computer-readable storage medium having stored instructions thereon that may be used to program a computer (or other electronic device) to perform processes described herein. The computer-readable storage medium may include, but is not limited to: hard drives, floppy diskettes, optical disks, CD-ROMs, DVD-ROMs, ROMs, RAMs, EPROMs, EEPROMs, magnetic or optical cards, solid-state memory devices, or other types of medium/machine-readable medium suitable for storing electronic instructions.

As used herein, a software module or component may include any type of computer instruction or computer executable code located within a memory device and/or computer-readable storage medium. A software module may, for instance, comprise one or more physical or logical blocks of computer instructions, which may be organized as a routine, program, object, component, data structure, etc., that perform one or more tasks or implements particular abstract data types.

In certain embodiments, a particular software module may comprise disparate instructions stored in different locations of a memory device, which together implement the described functionality of the module. Indeed, a module may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

We claim:

1. An interface for displaying an intersection space, comprising:
a timeframe control configured to display a prevailing timeframe on a display of a computing device and to modify the prevailing timeframe displayed on the display of the computing device in response to a gesture input; and
an intersecting story region configured to display at least a portion of a set of story indicators on the display of the computing device, each story indicator corresponding to a respective story comprising timeframe metadata that intersects with the prevailing timeframe, wherein the intersecting story region is configured to modify the set of story indicators in response to a modification of the prevailing timeframe of the timeframe control.

2. The interface of claim 1, wherein the gesture input comprises a touch input on the display of the computing device.

3. The interface of claim 1, wherein the gesture input comprises tilting the display of the computing device.

4. The interface of claim 1, wherein the timeframe control is configured to modify a granularity of the prevailing timeframe in response to the gesture input.

5. The interface of claim 4, wherein the gesture input comprises one of a pinch touch gesture and a spread touch gesture.

6. The interface of claim 1, wherein the timeframe control is configured to modify a start time and an end time of the prevailing timeframe in response to the gesture input.

7. The interface of claim 6, wherein the gesture input comprises one of a flick touch gesture, a pan touch gesture, and a tilt orientation gesture.

8. The interface of claim 1, wherein the intersection space display is configured to order the set of story indicators based upon a relative start time metric.

9. The interface of claim 1, wherein the intersection space display is configured to order the set of story indicators based upon a timeframe correspondence metric.

10. The interface of claim 1, wherein the intersection space display is configured to order the set of story indicators based upon a chronological importance metric.

11. The interface of claim 1, wherein the set of story indicators correspond to stories that intersect with the prevailing timeframe and at least one other intersection criteria.

12. The interface of claim 1, wherein the timeframe control further comprises an intersection indicator region configured to display one or more intersection indicators on the display of the computing device, each intersection indicator corresponding to a time within the timeframe control of one or more stories that intersect the prevailing timeframe.

13. The interface of claim 12, wherein the intersection indicator region indicates a relative density of story intersections within a portion of the prevailing timeframe.

14. A method for displaying an intersection space on a display of a computing device, the method comprising:
displaying a timeframe control on a display of a computing device, the timeframe control comprising a prevailing timeframe;
displaying at least a portion of a set of story indicators on the display of the computing device, wherein each story indicator in the set of story indicators corresponds to a story that intersects with the prevailing timeframe of the timeframe control;
modifying the prevailing timeframe of the timeframe control displayed on the display of the computing device in response to a gesture input.

15. The method of claim 14, wherein the gesture input is a touch input.

16. The method of claim 14, wherein the gesture input comprises one or more of moving and orienting the display of the computing device.

17. The method of claim 14, further comprising modifying the set of story indicators in response to modifying the prevailing timeframe.

18. The method of claim 14, further comprising displaying an intersection indicator region on the timeframe control, the intersection indicator region comprising one or more intersection indicators, each intersection indicator corresponding to a time within the prevailing timeframe of an intersection of one or more stories of the set of story indicators.

19. The method of claim 18, further comprising displaying a relative density of story intersections within a portion of the prevailing timeframe in the intersection indicator region.

20. A non-transitory computer-readable storage medium comprising instructions configured to cause a computing device to perform a method, comprising:
displaying a timeframe control on a display of a computing device, the timeframe control comprising a prevailing timeframe;
identifying one or more stories that intersect with the prevailing timeframe of the timeframe control and a location intersection criteria;
displaying at least a portion of a set of story indicators on the display of the computing device, each story indicator corresponding to a respective one of the identified stories;
displaying an intersection indicator region on the timeframe control, the intersection indicator region comprising one or more intersection indicators, each intersection indicator corresponding to a time within the prevailing timeframe of an intersection of one or more of the identified stories;
modifying the prevailing timeframe of the timeframe control displayed on the display of the computing device in response to a gesture input; and
modifying the set of story indicators in response to modifying the prevailing timeframe.
